(19) United States
(12) Patent Application Publication
(10) Pub. No.: US 2014/0006042 A1
(43) Pub. Date: Jan. 2, 2014

(54) METHODS FOR CONDUCTING STUDIES

(71) Applicants: Richard Keefe, Chapel Hill, NC (US); Vicki Davis, Chapel Hill, NC (US); Michael Hufford, Chapel Hill, NC (US); Nicole Turcotte, Cary, NC (US); Jenna Piunti, Chapel Hill, NC (US)

(72) Inventors: Richard Keefe, Chapel Hill, NC (US); Vicki Davis, Chapel Hill, NC (US); Michael Hufford, Chapel Hill, NC (US); Nicole Turcotte, Cary, NC (US); Jenna Piunti, Chapel Hill, NC (US)

(21) Appl. No.: 13/799,780

(22) Filed: Mar. 13, 2013

Related U.S. Application Data
(60) Provisional application No. 61/644,142, filed on May 8, 2012.

(51) Int. Cl. G06F 19/00

(52) U.S. Cl. CPC G06F 19/363
USPC 705/2

(57) ABSTRACT

Provided herein are methods, devices, systems, and computer readable medium for improving studies such as clinical trials and for improving clinical practice. The methods, devices, systems, and computer readable medium provided herein can be used to identify outlier data in a study, select data collection sites likely to produce high quality data, detect fraud, identify placebo responders, and/or identify likely responders to a therapy. The methods, devices, systems, and computer readable medium provided herein can also be used to optimize a test, for example, a neurocognitive battery, for maximum sensitivity.

### CROSS-REFERENCE

This application claims the benefit of U.S. Provisional Application No. 61/644,142, filed May 8, 2012, which application is incorporated herein by reference in its entirety.

### BACKGROUND

There is a need for improving the quality studies such as clinical trials and for improving clinical practice. For instance, there is a need for improved methods of determining whether fraud may have occurred in a study, e.g., a study related to a neurocognitive assessment. Further, there is a need for improved methods of determining whether a subject will manifest a placebo response to a therapy. For example, there is a need from improved methods of identifying subjects likely to manifest a placebo response as measured by the administration of a neurocognitive battery. There is also a need for improved methods of identifying subjects that are likely to respond to or benefit from a therapy. For example, there is a need to identify subjects likely to benefit from pharmaceutical and/or psychosocial interventions to improve their cognitive performance.

There is also a need for improved methods of detecting outlier data and correct outlier data in studies. For example, there is a need for improved methods of identifying outlier data among neurocognitive data.

Moreover, there is a need for improved methods of selecting data collection sites that are likely to produce high quality data. For example, there is a need for improved methods of determining whether a prospective clinical trial site is likely to produce high quality neurocognitive data.

Furthermore, there is also a need for improved methods of neurocognitive item selection for maximum sensitivity to a therapeutic intervention.

### SUMMARY

Fraud Detection

In one aspect, a method of performing a study is provided, the method comprising a) acquiring a first set of data comprising one or more responses to one or more assessments administered to a subject; b) comparing the first set of data from the subject to a second set of data, wherein the comparing comprises execution of an algorithm on an electronic device; c) generating a fraud index based on the comparing, wherein the fraud index indicates the probability that the first set of data comprises fraudulent data; d) determining the presence or absence of fraudulent data based on the fraud index; and e) modifying the first set of data if fraudulent data is present in the first set of data.

In another aspect, a method of generating a fraud index for data is provided, the method comprising a) acquiring a first set of data, wherein the first set of data comprises one or more responses to one or more assessments administered to a subject; b) comparing the first set of data from the subject to a second set of data, wherein said comparing comprises execution of an algorithm on an electronic device; and c) generating a fraud index based on the comparing, wherein the fraud index indicates the probability that the first set of data comprises fraudulent data.

In another aspect, a system for generating a fraud index is provided, wherein the system comprises computer readable instructions for a) acquiring a first set of data comprising one or more responses to one or more assessments administered to a subject; b) comparing the first set of data from the subject to a second set of data, wherein the comparing comprises execution of an algorithm on an electronic device; and c) generating a fraud index based on the comparing, wherein the fraud index indicates the probability that the first set of data comprises fraudulent data.

In another aspect, a non-transitory computer readable medium for generating a fraud index is provided, wherein the non-transitory computer readable medium has stored thereon sequences of instructions which, when executed by a computer system cause the computer system to perform a) acquiring a first set of data comprising one or more responses to one or more assessments administered to a subject; b) comparing the first set of data from the subject to a second set of data, wherein the comparing comprises execution of an algorithm on an electronic device; and c) generating a fraud index based on the comparing, wherein the fraud index indicates the probability that the first set of data comprises fraudulent data.

The first set of data and second set of data can be neurocognitive data. The one or more assessments can be one or more neurocognitive assessments. The second set of neurocognitive data can comprise one or more responses to one or more neurocognitive assessments administered to the subject. The second set of neurocognitive data can be neurocognitive data previously obtained from the subject. The second set of neurocognitive data can comprise one or more responses to one or more neurocognitive assessments administered to one or more other subjects that do not include the first subject. The one or more other subjects can be part of the same study as the first subject. The first set of neurocognitive data and the second set of neurocognitive data can be derived from the same test. The first set of neurocognitive data and the second set of neurocognitive data can be derived from the same study. The first set of neurocognitive data and the second set of neurocognitive data can be derived from different studies within the same therapeutic indication. The first set of neurocognitive data and the second set of neurocognitive data can be derived from different studies with different therapeutic indications. The fraud index can be based on a statistical improbability. The statistical improbability can comprise unusually low inter-subject variability. In some cases, faked data does not fluctuate as would be expected across subjects

The statistical improbability can comprise unusual inter-session variability. The unusual inter-session variability can comprise high consistency across testing sessions that would not be expected. The unusual inter-session variability can comprise change from a previous assessment from the same subject in the first set of neurocognitive data that would not be predicted based on the second set of neurocognitive data, wherein the second set of neurocognitive data comprise a database of previous scores from the same neurocognitive battery. The statistical improbability can comprise improbable timing for a neurocognitive test, wherein reaction time is recorded in the first set of neurocognitive data. The improbable timing can comprise the same subject having identical reaction times in the first set of neurocognitive data and the second set of neurocognitive data, wherein first set of neurocognitive data and the second set of neurocognitive data are from different testing sessions. The improbable timing can comprise identical reaction times in a computerized measure of sustained focused attention for the subject in the first set of neurocognitive data and for a different subject in the second set of neurocognitive data.

In some cases, the fraud index is generated based on clinical profile improbability. The clinical profile improbability can be based on high correlation among cognitive subtests in the second set of neurocognitive data. A large subscale change can have a low probability if it occurs in isolation.

The clinical profile improbability can be based on a temporal pattern of change over time.

In some cases, the fraud index is an unweighted metric. In some cases, the fraud index is a weighted metric. The weighted metric can be based on a relationship to normative data in the second set of neurocognitive data or past performance by the subject on previous neurocognitive test administrations.

In some cases, the fraud index is derived from a formula: fraud index=statistical threshold metric+across subtest comparison metric+across patient metric. The fraud index can have a sample range of 0-3. In some cases, the statistical threshold metric equals 0 if a change score in the first set of neurocognitive data is less than 3 standard deviations from healthy normative data in the second set of neurocognitive data, and wherein the statistical threshold metric equals 1 if a change score in the first set of neurocognitive data is greater than or equal to 3 standard deviations from healthy normative data in the second set of neurocognitive data.

In some cases, the across subtest comparison metric is 1 if the difference of a subtest score to an overall composite score on other subtests is greater than 15 T-score points, and wherein the across subtest comparison metric is 0 otherwise. In some cases, the across-patient metric is 1 if a subject's raw score is greater than 3 standard deviations from the mean raw score from all other subject's scores on that subtest at that visit, and the across-patient metric is zero otherwise.

Determining the fraud index can comprise data mining.

In some cases, the modifying comprises excluding data from the first set of neurocognitive data from further analysis. The excluding the neurocognitive data can enhance the overall quality of the first set of neurocognitive data. The quality of the first set of neurocognitive data can be measured by psychometric indexes. The psychometric index can comprise intraclass correlation coefficient.

In some cases, the first set of data is collected as part of a drug development program. The first set of data and/or second set of data can be scored at a centralized location. The one or more neurocognitive assessments can comprise a battery of neurocognitive tests. The first set of data and second set of data can be from different data collection sites.

In some cases, the electronic device is a computer.

Site Quality Index

In another aspect, a method of performing a study is provided, the method comprising a) obtaining data concerning the performance of one or more data collection sites in conducting one or more studies; b) obtaining information regarding one or more additional features of the one or more data collection sites; c) analyzing the information and data, wherein the analyzing comprises executing an algorithm on an electronic device; d) generating a site quality index based on the analyzing, wherein the site quality index provides an indication of quality of the one or more data collection sites; and d) selecting or excluding one or more data collection sites from a study based on the site quality index.

In another embodiment, a method of evaluating one or more data collection sites is provided, the method comprising: a) obtaining data concerning the performance of one or more data collection sites in conducting one or more studies; b) obtaining information regarding one or more additional features of the one or more data collection sites; c) analyzing the information and data, wherein the analyzing comprises executing an algorithm on an electronic device; and d) generating a site quality index based on the analyzing, wherein the site quality index provides an indication of quality of the one or more data collection sites.

In another embodiment, a system for evaluating one or more data collection sites is provided, the system comprising computer readable instructions for a) obtaining data concerning the performance of one or more data collection sites in conducting one or more studies; b) obtaining information regarding one or more additional features of the one or more data collection sites; c) analyzing the information and data, wherein the analyzing comprises executing an algorithm on an electronic device; and d) generating a site quality index based on the analyzing, wherein the site quality index provides an indication of quality of the one or more data collection sites.

In another embodiment, a non-transitory computer readable medium for evaluating one or more data collection sites is provided, the non-transitory computer readable medium having stored thereon sequences of instructions, which, when executed by a computer system, cause the computer system to perform a) obtaining data concerning the performance of one or more data collection sites in conducting one or more studies; b) obtaining information regarding one or more additional features of the one or more data collection sites; c) analyzing the information and data, wherein the analyzing comprises executing an algorithm on an electronic device; and d) generating a site quality index based on the analyzing, wherein the site quality index provides an indication of quality of the one or more data collection sites.

In some cases, the study is a research study. The study can be a clinical study. The study can be a neurocognitive study. The one or more data collection sites can comprise one or more neurocognitive data collection sites. The information can comprise i) setting of the one or more data collection sites, ii) principal investigator at the one or more data collection sites, iii) number of neurocognitive raters at the one or more data collection sites, iv) experience of neurocognitive raters at the one or more data collection sites, v) number of subjects observed at the one or more data collection sites, and/or vi) past enrollment performance in previous studies at the one or more data collection sites.

In some cases, the setting of the one or more data collection sites comprise an academic and/or professional setting. In some cases, the experience of neurocognitive raters at the one or more data collection sites comprises experience with pasts tests used in one or more previous clinical trials. The experience of neurocognitive raters at the one or more data collection sites can comprise experience with one or more neurocognitive batteries used in the study. The performance can comprise the number of administration errors in a study at the one or more data collection sites. The performance can comprise the timing of one or more administration errors in a study at the one or more data collection sites. The timing can be early in a study and/or late in a study.

In some cases, the performance can comprise one or more types of administration errors produced by neurocognitive raters at the one or more data collection sites. The performance can comprise a number of scoring errors produced by neurocognitive raters at the one or more data collection sites. The performance can comprise the timing of one or more scoring errors produced by neurocognitive raters at one or more data collection sites. The performance can comprise type of scoring errors produced at one or more data collection sites. The performance can comprise a magnitude of a placebo response at the one or more data collection sites. The magnitude of a placebo response can be a change from baseline among subjects enrolled in a placebo group. The performance can be the magnitude of a placebo response separation from an active treatment group response. The performance can be a comparison of a magnitude of a first placebo response at a first data collection site to a magnitude of a second placebo response at a second data collection site.

In some cases, the first placebo response and second placebo response are in the same study. The first placebo response and second placebo response can be in different studies. The performance can comprise one or more occurrences of fraud at the one or more data collection sites. The one or more occurrences of fraud at the one or more research sites can comprise the manufacture of neurocognitive data on the part of staff in the absence of administering some or all of a neurocognitive test battery to a subject.

In some cases, the site quality index can be determined by rank ordering data collection sites to classify sites along a continuum of performance. The performance can comprise errors involving misapplication of discontintuation rules.

In some cases, the site quality index can be based on an unweighted or weighted metric. In some cases, the unweighted site quality index is derived from the formula: Site Quality Index=[(Σᵢ₌₁^{N} Administration Errorsᵢ)+(Σᵢ₌₁^{N} Scoring Errorsᵢ)+(Σᵢ₌₁^{N} Number of T−score subscore changesᵢΣᵢ₌₁^{N} Scoring Errorsᵢ)+(Σᵢ₌₁^{N} Number of T−score composite changesᵢ) Σᵢ₌₁^{N} Number of T−score composite changesᵢ]/# Administrations of the measures.

In some cases, the weighted site quality index is derived from the formula: Site Quality Index=[(Σᵢ₌₁^{N} (Administration Errorsᵢ))+(Σᵢ₌₁^{N} Scoring ErrorsᵢΣᵢ₌₁^{N} Administration Errorsᵢ)+(Σᵢ₌₁^{N} Magnitude of T−score subscore changesᵢΣᵢ₌₁^{N} Scoring Errorsᵢ)+(Σᵢ₌₁^{N} Magnitude of T−score composite changesᵢ) Σᵢ₌₁^{N} Number of T−score composite changesᵢ]# Administrations of the measures.

The one or more data collection sites can be in on Σᵢ₌₁¹ or more drug development programs. The study can be a study of bipolar disorder, schizophrenia, or Alzheimer's disease. The electronic device can be a computer.

Data Outlier Index

In another aspect, a method for performing a study is provided, the method comprising a) acquiring a first set of data, wherein the first set of data comprises one or more responses to one or more assessments administered to a subject; b) comparing the first set of data to a second set of data, wherein the comparing comprises execution of an algorithm on an electronic device; c) determining a data outlier index based on the comparing; and d) modifying the first set of data based on the data outlier index.

In another aspect, a method for determining whether data in a first set of data from a subject in a study is aberrant is provided, the method comprising a) acquiring the first set of data, wherein the first set of data comprises one or more responses to one or more assessments administered to a subject; b) comparing the first set of data to a second set of data, wherein the comparing comprises executing an algorithm on an electronic device; and c) determining a data outlier index based on the comparing.

In another aspect, a system for determining a data outlier index is provided, the system comprising computer readable instructions for a) acquiring a first set of data, wherein the first set of data comprises one or more responses to one or more assessments administered to a subject; b) comparing the first set of data to a second set of data, wherein the comparing comprises execution of an algorithm on an electronic device; and c) determining a data outlier index based on the comparing. In some cases, a step of modifying the first set of data based on the data outlier index is provided.

In another aspect, a non-transitory computer readable medium for determining a data outlier index is provided, the non-transitory computer readable medium having stored thereon sequences of instructions, which, when executed by a computer system, cause the computer system to perform a) acquiring a first set of data, wherein the first set of data comprises one or more responses to one or more assessments administered to a subject; b) comparing the first set of data to a second set of data, wherein the comparing comprises execution of an algorithm on an electronic device; and c) determining a data outlier index based on the comparing. In some cases, a step of modifying the first set of data based on the data outlier index is provided.

The first set of data and second set of data can be neurocognitive data. The one or more assessments can be one or more neurocognitive assessments. The second set of neurocognitive data can comprise one or more responses to one or more neurocognitive assessments administered to the subject. The second set of neurocognitive data can comprise one or more responses to one or more neurocognitive assessments administered to one or more other subjects that do not include the first subject. The one or more other subjects can be part of the same study as the first subject.

The one or more other subjects can be in a different study than the first subject. The different studies can have the same therapeutic indication. The different studies can have different therapeutic indications.

In some cases, the data outlier index is based on comparing a single score from the first set of data to the second set of data, wherein the second set of data is a database of historical scores from assessments of other subjects. The data outlier index can be based on comparing a pattern of responses in the first set of data to a historic database of responses in the second set of data. The data outlier index can be based on a clinical profile improbability. The clinical profile improbability can be based on a high correlation among multiple subtests in the second set of data. In some cases, a large subscale change has a low probability if it occurs in a single test.

In some cases, the subject has a condition, and the subject is being treated for the condition, and the clinical profile improbability is based on a specific pattern of cognitive deficits associated with the condition being treated. The condition can be bipolar disorder, schizophrenia, or Alzheimer's disease. The clinical profile improbability can be based on the rate of change of a cognitive parameter in the first set of neurocognitive data compared to the second set of neurocognitive data. The rate of change of a cognitive parameter in the first set of neurocognitive data can be accelerated relative to the rate of change of the cognitive parameter in the second set of neurocognitive data. The comparing can comprise comparing a single score in the first set of neurocognitive data to a single score in the second set of neurocognitive data. The comparing can comprise comparing a change in scores in the first set of neurocognitive data to a change of scores in the second set of neurocognitive data.

In some cases, the data outlier index is an unweighted metric. In some cases, the data outlier index is a weighted metric. The weighted metric can be based on a comparison between the first set of data and the second set of data. In some cases, the first set of data and the second set of data are from the same subject. In some cases, the second set of data is a database of historical scores from assessments of other subjects. In some cases, the data outlier index is derived from a formula, wherein the formula is: data outlier index=statistical threshold metric+across subtest comparison metric+across patient metric. The data outlier index can have a sample range of 0-3. In some cases, the statistical threshold metric equals 0 if a score in the first set of neurocognitive data is less than 3 standard deviations from the mean of a score in the second set of neurocognitive data, and wherein the statistical threshold metric equals 1 if a score in the first set of data is greater than or equal to 3 standard deviations from a score in the second set of data.

The second set of data can comprise healthy normative data. The across subtest comparison metric can be 1 if the difference of a subtest score in the first set of data to an overall composite score on other subtests in the first set of data is greater than 15 T-score points, and wherein the across subtest comparison metric is 0 otherwise. The across-patient metric can be 1 if a subject's raw score in the first set of data is greater than 3 standard deviations from the mean raw score from all other subject's scores in the second set of data on that subtest at a visit, and the across-patient metric is zero otherwise.

In some cases, determining the outlier data index comprises data mining.

In some cases, the data outlier index is based on a statistical improbability. The statistical improbability can be that one or more datum in the first set of data is greater than 3 standard deviations from the mean of one or more datum in the second set of data.

The modifying can comprise excluding one or more datum from the first set of data from further analysis. The excluding the data can enhance the overall quality of the first set of data. The quality of the first set of data can be measured by one or more psychometric indexes. The one or more psychometric indexes can comprise an intraclass correlation coefficient.

In some cases, a further step comprising seeking clarification from a rater at a site who administered an assessment to determine if either the administration or scoring was in error is provided. The modifying can comprise providing a correct score to be entered into a database for analysis.

In some cases, a further step comprising imputing the data using a conventional statistical method of imputation is provided.

The first set of data can be collected as part of a drug development program. In some cases, inclusion of aberrant data in a study would lead to a false positive or false negative error for a subject meeting a diagnostic or treatment-related threshold regarding their cognitive function.

The assessment can comprise an error. The error can be an error in administration of a neurocognitive assessment. The error can be an error in scoring a neurocognitive assessment. The assessment can be scored at a central location. The assessment can be scored at a non-central location. The assessment can comprise a battery of neurocognitive tests.

The electronic device can be a computer.

Responder Index

In another aspect, a method of treating a subject with a condition is provided, the method comprising a) administering one or more tests to the subject; b) comparing scores from the one or more tests to scores from the one or more tests from one or more other subjects; c) generating a responder index based on the comparing, wherein the responder index quantifies the probability that the subject will show an improvement to one or more therapies, wherein the generating comprises executing an algorithm on an electronic device; d) comparing the responder index to a threshold; e) determining whether the subject is a likely responder based on d); and f) enrolling or not enrolling the subject in the clinical trial based on e).

In another aspect, a method of generating a responder index reflecting the likelihood a subject will respond to one or more therapies for a condition is provided, the method comprising a) administering one or more tests to the subject; b) comparing the scores from the one or more tests to scores from the one or more tests from one or more other subjects; and c) generating a responder index based by executing an algorithm on an electronic device, wherein the responder index quantifies the probability that the subject will show a improvement to one or more therapies.

In another aspect, a system for generating a responder index reflecting the likelihood a subject will respond to one or more therapies for a condition is provided, the system comprising computer readable instructions for a) comparing scores from one or more tests administered to the subject to scores from the one or more tests from one or more other subjects; and b) generating a responder index based on the comparing, wherein the responder index quantifies the probability that the subject will show an improvement to one or more therapies, wherein the generating comprises executing an algorithm on an electronic device. The system can further comprise instructions for c) comparing the responder index to a threshold; d) determining whether the subject is a likely responder based on b); and e) enrolling or not enrolling the subject in the clinical trial based on d).

In another aspect, a non-transitory computer readable medium for generating a responder index reflecting the likelihood a subject will respond to one or more therapies for a condition is provided, wherein the non-transitory computer readable medium has stored thereon sequences of instructions which, when executed by a computer system cause the computer system to perform a) comparing scores from one or more tests administered to the subject to scores from the one or more tests from one or more other subjects; b) generating a responder index based on the comparing, wherein the responder index quantifies the probability that the subject will show an improvement to one or more therapies, wherein the generating comprises executing an algorithm on an electronic device. The non-transitory computer readable medium can have stored thereon sequences of instructions which, when executed by a computer system cause the computer system to perform c) comparing the responder index to a threshold; d) determining whether the subject is a likely responder based on b); and e) enrolling or not enrolling the subject in the clinical trial based on d).

In some cases, the condition is a neurocognitive condition. The one or more tests can be one or more neurocognitive tests. The improvement can be a neurocognitive improvement. In some cases, a step of further administering a treatment to the subject is provided. The administering can comprise starting a new therapy or making a change to an existing therapeutic regimen for the subject.

The scores to the one or more tests can be received at a central location. The data from one or more other subjects can comprise profiles of subjects who have previously been responsive to a therapy. The profiles can be neurocognitive profiles, symptomatic profiles, and/or pharmacogenomic profiles. The responder index can be generated based on additional information. The additional information can comprise a functional capacity measure. The functional capacity measure can comprise the ability of improvements in specific areas of cognition to translate into meaningful improvements in a subject's ability to complete daily tasks.

The daily tasks can include employment. The additional information can comprise one or more pharmacogenomic tests. The additional information can comprise a lifestyle factor of the subject. The lifestyle factor can be whether or not the subject smokes. The electronic device can be a computer.

Placebo Responder Index

In another aspect, a method of performing a study for a condition is provided, the method comprising a) acquiring a first set of data, wherein the first set of data comprises one or more responses to one or more assessments administered to a subject; b) acquiring additional information about the subject; c) generating a placebo responder index based on the first set of data and the information, wherein the placebo responder index is generated by executing an algorithm on an electronic device; and d) modifying the study based on a likelihood the subject will respond to placebo.

In another aspect, a method of generating a placebo responder index for a subject is provided, the method comprising a) acquiring a first set of data, wherein the first set of data comprises one or more responses to one or more assessments administered to a subject; b) acquiring additional information about the subject; and c) generating a placebo responder index based on the first set of data and the information, wherein the placebo responder index is generated by executing an algorithm on an electronic device.

In another aspect, a system for generating a placebo responder index for a subject is provided, the system comprising computer readable instructions for a) acquiring a first set of data, wherein the first set of data comprises one or more responses to one or more assessments administered to a subject; b) acquiring additional information about the subject; and c) generating a placebo responder index based on the first set of data and the information, wherein the placebo responder index is generated by executing an algorithm on an electronic device. In some cases, the system further comprises instructions for modifying a study based on the likelihood the subject will respond to placebo.

In another aspect, a non-transitory computer readable medium for generating a placebo responder index for a subject is provided, wherein the non-transitory computer readable medium has stored thereon sequences of instructions which, when executed by a computer system cause the computer system to perform a) acquiring a first set of data, wherein the first set of data comprises one or more responses to one or more assessments administered to a subject; b) acquiring additional information about the subject; and c) generating a placebo responder index based on the first set of data and the information, wherein the placebo responder index is generated by executing an algorithm on an electronic device. In some cases, wherein the non-transitory computer readable medium has stored thereon sequences of instructions which, when executed by a computer system cause the computer system to perform modifying a study based on the likelihood the subject will respond to placebo.

The condition can be a neurocognitive condition. The first set of data can be neurocognitive data. In some cases, the one or more assessments are one or more neurocognitive assessments. The one or more neurocognitive assessments can comprise a neurocognitive test battery. The neurocognitive test battery can comprise a screening battery. The additional information can comprise symptoms of the subject, past treatment history of the subject, personality of the subject, and/or response of the subject to one or more other psychological or physiological assessments. The placebo responder index can be compared to a database of indexes from subjects who have participated in other studies.

The subject can be in a clinical trial of a pharmacotherapy for cognitive impairments in schizophrenia.

The placebo responder index can be generated using the formula: Placebo Responder Index=(difference between a baseline T-score on neurocognitive test A and a score on neurocognitive test A after 6 weeks of treatment) X (the percent improvement between baseline and Week 6 on a measure of the subject's psychotic symptoms).

The algorithm can use parametric techniques, nonparametric techniques, and/or data mining. The algorithm can uncover latent variables. The algorithm can predict the probability and magnitude of a placebo response. In some cases, a step of further communicating information regarding the placebo response index for a subject to a study sponsor is provided.

The subject can be enrolled in a clinical trial. The clinical trial can be for a drug. The electronic device can comprise a computer. The modifying can comprise modifying the subject's enrollment or status in the study. The modifying can comprise changing a distribution allocation of subjects among different treatment groups.

Neurocognitive Battery

In another aspect, a method of generating an optimized neurocognitive battery is provided, the method comprising a) administering one or more neurocognitive batteries to a plurality of subjects with a neurocognitive condition; b) creating a database of results of the one or more neurocognitive batteries; c) analyzing the database by executing an algorithm on an electronic device; and d) identifying an optimized neurocognitive battery based on the analyzing.

In another aspect, a system for identifying an optimized neurocognitive battery is provided, the system comprising computer readable instructions for a) analyzing a database of results of one or more neurocognitive batteries by executing an algorithm on an electronic device, wherein the results are generated by administering one or more neurocognitive batteries to a plurality of subjects; and b) identifying an optimized neurocognitive battery based on the analyzing.

In another aspect, a non-transitory computer readable medium for identifying an optimized neurocognitive battery is provided, the non-transitory computer readable medium having stored thereon sequences of instructions which, when executed by a computer system, cause the computer system to perform a) analyzing a database of results of one or more neurocognitive batteries by executing an algorithm on an electronic device, wherein the results are generated by administering one or more neurocognitive batteries to a plurality of subjects; and b) identifying an optimized neurocognitive battery based on the analyzing.

In some cases, the plurality of subjects receives therapy for one or more cognitive impairments associated with a condition. The optimized battery can comprise stimuli or questions that are maximally sensitive to the therapy. In some cases, the identifying the optimized neurocognitive battery comprises computational approaches. The computational approaches can include item response theory or Rasch analysis. The optimized neurocognitive battery can be applied to a future clinical study. The optimized neurocognitive battery can be applied to a pre-existing database of a clinical trial to confirm the ability of the optimized neurocognitive battery to enhance signal detection in a clinical trial. The ability to enhance signal detection can comprise demonstrating a difference between an effective treatment and a placebo. The neurocognitive condition can comprise Alzheimer's disease, bipolar disorder, or schizophrenia.

In some cases, the electronic device is a computer.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an embodiment of a method of generating and using a fraud index.

FIG. 2 illustrates an embodiment of a method of generating and using a site quality index.

FIG. 3 illustrates an embodiment of a method of generating and using a data outlier index.

FIG. 4 illustrates an embodiment of a method of generating and using a likely responder index.

FIG. 5 illustrates an embodiment of a method of generating and using a placebo responder index.

FIG. 6 illustrates an embodiment of a method of generating and using an optimized neurocognitive battery.

FIG. 7 illustrates an example of a network or host computer platform as can be used to implement a server or electronic devices, according to an embodiment.

FIG. 8 depicts a computer or electronic device with user interface elements, as can be used to implement a personal computer, electronic device, or other type of work station or terminal device according to an embodiment, although the computer or electronic device of FIG. 8 can also act as a server if appropriately programmed.

### DETAILED DESCRIPTION

Fraud Detection

Provided herein are methods, devices, systems, and computer readable medium for generating a fraud index, e.g., for one or more data, e.g., one or more neurocognitive data. The data can be generated in the course of a study, e.g., a clinical trial. The fraud index can indicate the probability that the one or more data are fraudulent or the result of fraud. The fraud index can be used to make a determination of whether one or more data are actually fraudulent.

Fraud can include, e.g., deceit, trickery, an act of deceiving, an act of misrepresentation, an act of omission, or an act of commission. In some embodiments, fraud can include not revealing all data and/or consciously altering or fabricating data. Fraud can occur in an initial design of a research process. In some embodiments, fraud can include a representation that a test was performed when it actually was not performed. Fraud can include copying data or a submission of false data. Fraud can include a representation that one or more individuals involved in conducting a study, e.g., a rater of a neurocognitive assessment, are qualified by, e.g., training and/or experience, when the one or more individuals do not have the represented training and/or experience. In some embodiments, fraud can include an omission of reasonable foreseeable risks or discomforts to a subject included in an informed consent document. In some embodiments, fraud does not include honest errors or differences in opinion. In some embodiments, fraud does not include ignorance of regulations or good practices, negligence, or sloppiness.

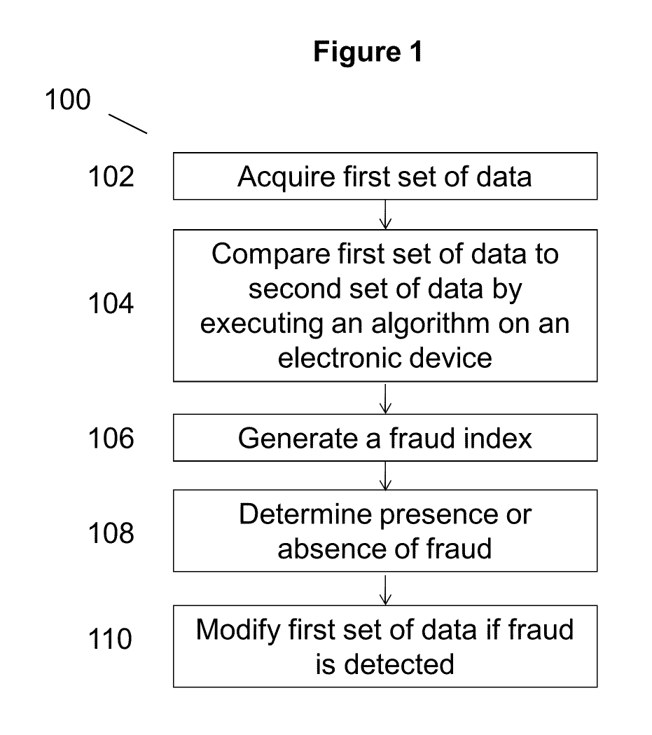

FIG. 1 illustrates an embodiment of a method (100) of generating a fraud index. The method can comprise acquiring one or more first data (102). The one or more first data can comprise one or more responses to one or more assessments administered to a subject. The method can comprise comparing the one or more first data from the subject to one or more second data (104). The comparing can comprise execution of an algorithm on an electronic device. The method can comprise generating a fraud index based on the comparing (106). The fraud index can indicate the probability that the one or more first data comprise fraudulent data.

In another aspect, a device or apparatus for generating a fraud index is provided. The device can be, e.g., an electronic device, e.g., a computer. Additional examples of suitable electronic devices for generating a fraud index are described herein.

In another aspect, a system for generating a fraud index is provided. The system can comprise computer readable instructions for acquiring one or more first data from a subject and comparing the one or more first data from the subject to one or more second data. The comparing can comprise execution of an algorithm on an electronic device. The system can comprise computer readable instructions for generating a fraud index, and the fraud index can indicate the probability that the one or more first data comprise fraudulent data.

In another aspect, a non-transitory computer readable medium is provided for generating a fraud index. The non-transitory computer readable medium can have stored thereon sequences of instructions, which, when executed by a computer system, cause the computer system to perform: acquiring one or more data from a subject and comparing the one or more first data from the subject to one or more second data. The comparing can comprise execution of an algorithm on an electronic device. The non-transitory computer readable medium can have stored thereon sequences of instructions, which, when executed by a computer system, generate a fraud index. The fraud index can indicate the probability that the one or more first data comprise fraudulent data.

Fraud Index

Generating the fraud index can comprise comparing one or more first data (e.g., a first set of neurocognitive data) to one or more second data (e.g., a second set of neurocognitive data). For example, a database derived from neurocognitive and/or symptom data can be used to generate an algorithm to detect when fraud may have occurred in completion of a test battery.

Types of Data

The one or more first data and one or more second data can be generated by the same or different sites (e.g., clinic, hospital, doctor's office, academic institution, etc). For example, in some embodiments, the one or more first data and one or more second data are generated by the same site. In some embodiments, the one or more first data are generated at a first site and the one or more second data are generated at a second site, wherein the first site and the second site are different sites. In some embodiments, the one or more first data are generated at a plurality of sites. In some embodiments, the one or more second data are generated at a plurality of sites.

The data (e.g., psychological data, e.g., neurocognitive data) can be scored at the same or different sites. For example, in some embodiments, data to be used in generating a fraud index can be scored at a central site (e.g., neurocognitive data can be generated at multiple sites and sent to a central site for scoring or checks to ensure the accurate administration and scoring of the test battery at the site). In some embodiments, data to be used in generating a fraud index can be scored at two or more sites. The data scored at two or more sites can be transmitted to a central site for determining a fraud index.

The one or more first data and one or more second data (e.g., responses to questions) can be from the same or different subjects. For example, in some embodiments, the one or more first data and the one or more second data are from the same subject. In some embodiments, the one or more first data are from a first subject and the one or more second data are from a second subject, wherein the first subject and second subject are different subjects. In some embodiments, the one or more first data are from a first subject and the one or more second data are from one or more other subjects.

The one or more first data and one or more second data can be results from the same or different tests. For example, in some embodiments, the one or more first data and one or more second data are results from a first test. In some embodiments, the one or more first data are results from a first test, and the one or more second data are results from a second test, wherein the first test and the second test are different tests. In some embodiments, the one or more second data comprise parallel (normative) scores, e.g., from subjects who have completed a test similar to (or the same as) a test completed by the first subject.

The one or more first data and one or more second data can be part of the same or different studies (e.g., clinical trial). For example, the one or more first data and the one or more second data can be part of the same study. In some embodiments, the one or more first data and one or more second data are part of different studies. In some embodiments, the different studies can be within the same therapeutic indication. In other embodiments, the different studies are within a different therapeutic indication.

In some embodiments, the fraud index is based on comparing a single score from a first set of data to scores in a second set of data, wherein the second set of data is a database of historical scores from assessments of other subjects. In some embodiments, the fraud index is based on comparing a pattern of responses in a first set of data to a historic database of responses in a second set of data.

The one or more first data and one or more second data can be generated by one or more tests or assessments administered by the same or different tester (e.g., individual, physician, psychologist, healthcare provider, or rater of a neurocognitive test). For example, in some embodiments, the one or more first data and one or more second data are results from one or more tests administered by a first tester. In some embodiments, the one or more first data are from one or more tests administered by a first tester, and the one or more second data are from one or more tests administered by a second tester, wherein the first tester and second tester are different testers. In some embodiments, the one or more first data are from one or more tests administered by more than one tester (e.g., at least 2, 3, 4, 5, 6, 7, 8, 9, 10 or more testers). In some embodiments, the one or more second data are from one or more tests administered by more than one tester (e.g., at least 2, 3, 4, 5, 6, 7, 8, 9, 10 or more testers). In some embodiments, the one or more first data and one or more second data are both from one or more tests administered by more than one tester.

The one or more first data can be generated before, after, or at the same time, or about the same time, as the one or more second data. In some embodiments, the one or more first data are generated after the one or more second data are generated. In some embodiments, the one or more first data are generated before the one or more second data are generated. In some embodiments, the one or more first data are generated at the same time, or about the same time as the one or more second data.

In some embodiments, the length of time between the generation of the one or more first data and the one or more second data is about, more than about, at least about, or less than about 30 seconds, 1 min, 5 min, 10 min, 15 min, 20 min, 25 min, 30 min, 35 min, 40 min, 45 min, 50 min, 55 min, 1 hr, 2 hr, 3 hr, 4 hr, 5 hr, 6 hr, 7 hr, 8 hr, 9 hr, 10 hr, 11 hr, 12 hr, 15 hr, 18 hr, 20 hr, 24 hr, 2 days, 3 days, 4 days, 5 days, 6 days, 1 week, 2 weeks, 3 weeks, 1 month, 2 months, 3 months, 4 months, 5 months, 6 months, 7 months, 8 months, 9 months, 10 months, 11 months, 1 year, 2 years, 3 years, 4 years, 5 years, 6 years, 7 years, 8 years, 9 years, 10 years, 20 years, 30 years, 40 years, 50 years, 60 years, 70 years, or 80 years. In some embodiments, the length of time between the generation of the one or more first data and the one or more second data is about 1 min to 1 hr, about 1 hr to about 1 day, about 1 day to about 1 week, about 1 week to about 1 month, about 1 month to about 1 year, or about 1 year to about 10 years.

In some embodiments, one or more first data (e.g., a first set of data) and one or more second data (e.g., second set of data) are medical data. In some embodiments, the medical data are psychological data. In some embodiments, the psychological data are neurocognitive data. In some embodiments, the one or more first data and one or more second data are neurocognitive data.

In some embodiments, the one or more first data and one or more second data are generated by administration of one or more tests or assessments to one or more subjects. In some embodiments, the one or more second data comprises one or more responses to one or more tests or assessments administered to the subject. In some embodiments, the one or more tests or assessments are one or more medical tests or medical assessments. In some embodiments, the one or more medical tests or medical assessments are one or more psychological tests or psychological assessments. In some embodiments, the one or more psychological tests or assessments are one or more neurocognitive tests or assessments. In some embodiments, the one or more neurocognitive tests or assessments comprise a battery of neurocognitive tests. Examples of suitable tests and assessments for use in the methods, devices, apparatus, and computer readable medium described herein, including psychological assessments such as neurocognitive assessments, are described further herein.

In some embodiments, the one or more second data are in a database. In some embodiments, the one or more first data are in a database. In some embodiments, the one or more first data and one or more second data are in the same database. In some embodiments, the one or more first data are in a first database and the one or more second data are in a second database. In some embodiments, a database comprises data from one or more assessments, one or more assessments provided by one or more testers, one or more sites, one or more studies, and/or one or more subjects.

Data can comprise, e.g., a measurement, a response (e.g., to a question), a score (e.g., from a test), a reaction time, a journal entry, a diary entry, an observation, an objective measure, a subjective measure, a behavior, a sign, a symptom, a value, a sum of values, a trend, a number, etc. Data can be nominal data, ordinal data, interval (integer) data, ratio data, scale data, quantitative data (e.g., interval data or ratio data), parametric data (e.g., interval data or ratio data), non-parametric data (e.g., nominal data or ordinal data), a continuous measurement (e.g., measure made along a continuous scale, which can allow for fine sub-division), a discrete variable (e.g., variable measured across a set of fixed values (e.g., age in years, scoring level of happiness), patient- or subject-generated drawings assessing their visuospatial ability, completion of neurocognitive tasks such as mazes or trail making requiring some manual completion of a task in response to a stimulus or set of stimuli.

Variables Used to Generate a Fraud Index

Statistical Improbability

A variety of factors or variables can be considered to determine or generate a fraud index. In some embodiments, determining a fraud index is based on a statistical improbability. The statistical improbability can comprise unusually low inter-subject variability in data. Inter-subject variability can be the variability of one or more data between two or more different subjects. For example, data that does not fluctuate as would be expected across subjects or within a single subject over time may be faked data.

In some embodiments, the statistical improbability comprises unusual inter-session variability. Inter-session variability can be the variability of one more data in a first session as compared to one or more data in one or more second sessions. For example, the unusual inter-session variability can comprise high consistency across testing sessions that would not be expected. In some embodiments, the unusual inter-session variability can comprise a change from a previous assessment from the same subject that would not be predicted based on a second set of data. The second set of data can comprise a database of previous scores from the same test (e.g., the same neurocognitive battery).

In some embodiments, the statistical improbability comprises improbable timing for a neurocognitive test, wherein reaction time is recorded in one or more first data. In some embodiments, the improbable timing comprises the same subject having identical reaction times in a first set of neurocognitive data and a second set of neurocognitive data, wherein the first set of neurocognitive data and the second set of neurocognitive data are from different testing sessions. In some embodiments, the improbable timing comprises identical reaction times in a computerized measure of sustained focused attention (e.g., Continuous Performance Test-Identical Pairs) for a first subject in a first set of neurocognitive data and for a different subject in the second set of neurocognitive data.

In some embodiments, the statistical improbability is based on one or more of, two or more of, or all three of a) unusually low inter-subject variability, b) unusual inter-session variability, and c) improbable timing on a neurocognitive test where reaction time is recorded.

Clinical Profile Improbability

In other embodiments, the fraud index is generated based on a clinical profile improbability. The clinical profile improbability can be based on high correlation among cognitive subtests. In some embodiments, a large change on one of several neurocognitive tests, for example, has a low probability if it occurs in isolation (e.g., on one test and not in others). In some embodiments, the clinical profile improbability is based on a temporal pattern of change over time. For example, there can be a tendency for cognitive changes to be gradual versus abrupt. A rapid change in a cognitive score can be considered in a clinical profile improbability.

Indicators of Fraud

Indicators of fraud can include, e.g., alterations in source data, e.g., alteration in values that turn an ineligible subject into an eligible one, obliterated or missing subject identifiers, e.g., on ECG printouts, scans, laboratory reports; clinic note entries not in chronological order, clinic note entries apparently inserted between existing entries, handwriting similarities between documents from different subjects, e.g., diaries or Quality of Life (QOL) questionnaires; subject diary cards of case report forms (CRFs) appear “too clean” and without errors, “too perfect” drug accountability records, similarities between different subject signatures on consent forms, monitoring visits frequently postponed by site staff, site staff frequently absent during planned monitoring visits, trial documentation not available for monitoring or long delays before documents are presented, delays in completion of case report forms, site staff are anxious, defensive, or complaining about monitor's behavior or attitude, investigator is obsessed with study payments, unusual or unexpected data—often detectable without visiting the site itself, e.g., unexpectedly low incidence of screen failures or adverse events, repeated values or number preference in data where variability is expected, data submitted at unusual times, on holidays, or at weekends.

Constructing a Fraud Index

In some embodiments, the fraud index is an unweighted metric. In some embodiments, the fraud index is a weighted metric. The weighted metric can be based on a relationship to normative data (e.g., one or more second data, e.g., neurocognitive data). In some embodiments, the weighted metric can be based on a relationship to past performance by the subject on a previous test administration, e.g., neurocognitive test.

In some embodiments, the fraud index is derived from the formula: fraud index=statistical threshold metric+across subtest comparison metric+across patient metric. In one example, a fraud index can have a sample range of 0-3. For example, the statistical threshold metric can equal 0 if a change score in one or more first data (e.g., neurocognitive data) is less than 3 standard deviations from normative data (e.g., healthy normative data) in one or more second data (e.g., neurocognitive data), and the statistical threshold metric can equal 1 if a change score in the one or more first data is greater than or equal to 3 standard deviations from normative data (e.g., healthy normative data) in the one or more second data. The across subtest comparison metric can be 1 if the difference of a subtest score to an overall composite score on other subtests is greater than 15 T-score points, and the across subtest comparison metric can be 0 otherwise. The across-patient metric can be 1 if a subject's raw score is greater than 3 standard deviations from the mean raw score from all other subject's scores on that subtest at that visit, and the across-patient metric can be zero otherwise.

In some embodiments, determining the fraud index can comprise data mining.

Expressing a Fraud Index

In some embodiments, the fraud index is expressed as a percentage. In some embodiments, the percentage is 0% (impossible to be fraudulent) or 100% (certain to be fraudulent). In some embodiments, the percentage is about, less than about, at least about, or more than about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%.

A fraud index can be expressed in other ways besides as a percentage. For example, in some embodiments, the fraud index is expressed on a scale from 0 (impossible to be fraudulent) to 1 (certain to be fraudulent). In some embodiments, the fraud index is 0 or 1. In some embodiments, when the fraud index scale is from 0 to 1, the fraud index is about, less than about, at least about, or more than about, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. The fraud index can be expressed using one or more other scales, e.g., 0 to 5, 0 to 10, 0 to 20, 0 to 30, 0 to 40, 0 to 50, 0 to 60, 0 to 70, 0 to 80, 0 to 90, 0 to 100, or 0 to 1000. In some embodiments, the fraud index is expressed using qualitative terms, e.g., “impossible,” “unlikely,” “almost certain,” “sure,” or “certain.” In some embodiments, the fraud index is expressed as a ratio. In some embodiments, the fraud index is expressed graphically, e.g., as a bar graph, pie chart, number line, bar chart, distribution probability, or cumulative percent.

Determining Presence or Absence of Fraud

A fraud index can provide an indication or probability that one or more data are fraudulent or are the result of fraudulent activity. The fraud index can be used to make a determination whether one or more data are fraudulent. For example, the determination can be made by comparing the fraud index to a threshold. The threshold can be a probability. In some embodiments, if the fraud index is below the threshold (e.g., the fraud index is a lower than the threshold probability), a determination is made that one or more data are not fraudulent. In some embodiments, if the fraud index is at or above the threshold (e.g., the fraud index is the same as or greater than the threshold probability), a determination is made that one or more are fraudulent. In some embodiments, if the fraud index is above the threshold (e.g., the fraud index is the same as or greater than the threshold probability), a determination is made that one or more data are fraudulent. The threshold can be established by a number of factors.

A threshold can be expressed in different ways; e.g., a threshold can be expressed in the same units as the fraud index. When the fraud index is expressed as a percentage, the threshold can be, e.g., about, less than about, at least about, or more than about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the threshold is 100%. When the fraud index is expressed on a scale from 0 to 1, the threshold can be about, less than about, at least about, or more than about 0.5, 0.55, 0.6, 0.65, 0.7, 0.75, 0.8, 0.85, 0.9, 0.95, 0.96, 0.97, 0.98, or 0.99. In some embodiments, the threshold can be 1. In some embodiments, when the fraud index is expressed in qualitative terms, the threshold is “certain” or “sure.”

In some embodiments, determining whether one or more data is fraudulent data based on a fraud index does not comprise comparing the fraud index to a threshold. In some embodiments, determining whether data is fraudulent based on a fraud index comprises performing an investigation. The investigation can be an investigation of one or more sites and/or individuals, e.g., a tester. The investigation can comprise reviewing records at a site, reviewing electronic visual and or auditory recordings at a site, and/or interviewing one or more individuals. In some embodiments, determining whether one or more data is fraudulent data comprises both comparing the fraud index to a threshold and conducting an investigation.

Actions

If a determination is made based on the fraud index that one or more data are fraudulent, one or more actions can be taken. In some embodiments, one or more actions can be taken even if one or more data are not determined to be fraudulent, or if it is not certain or clear that one or more data are fraudulent. In some embodiments, different actions are taken based on the value of the fraud index.

One or more entities, individuals, or parties can commit fraud or engage in fraudulent behavior. For example, fraud can be committed by a sponsor of a study, a contract research organization (CR®), an institutional review board (IRB), a clinical investigator, a subject or patient, or an agent or employee of any of the aforementioned.

The specific action to be taken can depend on the type of fraudulent data or the type of fraud. In some embodiments, one or more data in one or more first data are modified. The modification can be, e.g., a correction, amendment, recalculation, addition of data to the one or more first data, removal of data from the one or more first data, or excluding data from the one or more first data from further analysis. Excluding data (e.g., neurocognitive data) can enhance the overall quality of the one or more first data.

The quality of the one or more first data (e.g., neurocognitive data) can be measured by one or more psychometric indexes. For example, a psychometric index can comprise an intraclass correlation coefficient, which can be a measure of test reliability.

In some embodiments, if fraudulent data is from a site, e.g., such as an academic institution, hospital, corporation, or clinic, an action can be taken with respect to data generated by the site. For example, all data generated by the site that generated fraudulent data can be removed from the one or more first data. In other embodiments, only data that is determined to be fraudulent from a site is removed from the one or more first data.

In some embodiments, fraudulent data is generated by an individual or group of individuals, e.g., a rater of a neurocognitive assessment or head of a clinical study. In some embodiments, all data generated by the individual or group of individuals in the one or more first data can be modified. In some embodiments, less than all data in the one or more first data generated by the individual or group of individuals can be modified. In some embodiments, only data determined to be fraudulent from an individual in the one or more first data is modified. The modification can be, e.g., a correction, amendment, recalculation, addition of data to the first data set, removal of data from the first data set, or exclusion of data from further analysis. One or more modifications of the one or more first data can be performed.

In some embodiments, an action is taken with respect to a site, individual, or group of individuals that generates fraudulent data of data suspected of being fraudulent. In some embodiments, one or more communications are made to one or more authorities, e.g., a regulatory agency, e.g., Food and Drug Administration, Department of Health and Human Services (HHS), or Department of Justice, regarding the determination of fraud at a site or by an individual. In some embodiments, an authority conducts an investigation of a site and/or individual that produces fraudulent data or data suspected of being fraudulent.

Studies

The fraud index can be applied in the context of a study, e.g., a clinical trial or research study. Accordingly, provided herein are methods, systems, and computer readable medium for conducting a study. In one aspect, a method is provided for performing a study. FIG. 1 illustrates an embodiment of a method (100). The method can comprise acquiring a one or more first data (e.g., a first set of data) (102). The one or more first data can comprise one or more responses to one or more assessments administered to a subject. The method can comprise comparing the one or more first data from the subject to one or more second data, wherein the comparing comprises execution of an algorithm on an electronic device (104). The method can comprise generating a fraud index based on the comparing, wherein the fraud index indicates the probability that the one or more first data comprise fraudulent data (106). The method can comprise determining the presence or absence of fraudulent data in the one or more first data based on the fraud index (108). The method can comprise modifying the one or more first data if fraudulent data are present (110). The determining the presence or absence of fraudulent data can be by a method described herein. The modifying the one or more first data can be by a method described herein.

In other aspects, a device or apparatus for conducting a study is provided. The device can be, e.g., an electronic device, e.g., a computer, or, e.g., a mechanical device.

In another aspect, a system for conducting a study is provided. The system can comprise computer readable instructions for acquiring one or more first data from a subject; comparing the one or more first data from the subject to one or more second data, where the comparing comprises execution of an algorithm on an electronic device; generating a fraud index, where the fraud index can indicate the probability that the one or more first data comprise fraudulent data; determining the presence or absence of fraudulent data; and optionally modifying the one or more first data.

In another aspect, a non-transitory computer readable medium is provided for conducting a study. The non-transitory computer readable medium can have stored thereon sequences of instructions, which, when executed by a computer system, cause the computer system to perform: acquiring one or more first data from a subject; comparing the one or more first data from the subject to one or more second data, where the comparing comprises execution of an algorithm on an electronic device; generating a fraud index, where the fraud index can indicate the probability that the one or more first data comprise fraudulent data; determining the presence or absence of fraud; and optionally modifying one or more data in the one or more first data.

A study can be, e.g., a clinical trial, e.g., as described generally at clinicaltrials.gov/. The clinical trial can be, e.g., a treatment trial, a prevention trial, a diagnostic trial, screening trial, or a quality of life trial. A treatment trial can be, e.g., a trial to test experimental treatments, new drug combinations, or new approaches to surgery or radiation therapy. A prevention trial can be, e.g., a trial to prevent disease in people who have never had disease, or to prevent a disease from returning. A diagnostic trial can be, e.g., a trial to discover a better test or procedure for diagnosing a particular disease or condition. A screening trial can be, e.g., a trial to determine a method of detecting a disease or health condition. A quality of life trial (supportive care trial) can explore ways to improve comfort and/or the quality of life for individuals with, e.g., a chronic illness. One or more data (e.g., a first set of data) from a subject can be generated in clinical trial.

A clinical trial can comprise phases. For example, in a Phase 1 trial, an experimental drug or treatment can be tested in a small group of people (e.g., 20-80) for the first time to evaluate its safety, determine a safe dosage range, and identify side effects. In a Phase 2 trial, an experimental study drug or treatment can be given to a larger group of people (e.g., 100-300) who have the target illness of interest to determine if it is effective and to further evaluate its safety. In a Phase 3 trial, an experimental study drug or treatment can be given to a large group of people (e.g., 600-3000) to confirm its effectiveness, monitor side effects, compare the drug or treatment to commonly used treatments, and collect information that can allow the experimental drug or treatment to be used safely. In a Phase 4 trial, one or more post marketing studies can be used to delineate additional information including a drug's risks, benefits, and optimal use in clinical practice settings. One or more first data can comprise data from one or more phases of a clinical trial. In some embodiments, one or more first data can comprise data from one or more clinical trials.

The study can be an observational study or a randomized control trial. An observational study can be, e.g., a cohort study or a case-control study. In an observational study, associations (correlations) between treatments experienced by subjects and their health status or disease can be observed. A study can be randomized, double-blind, single-blind, open labeled or placebo-controlled.

In some embodiments, the study is a drug development program. In some embodiments, the study is not a clinical trial.

In some embodiments, a study is a National Institute of Mental Health (NIMH) study, e.g., Clinical Antipsychotic Trials of Intervention Effectiveness (CATIE), Measurement and Treatment Research to Improve Cognition in Schizophrenia (MATRICS), Treatment Units for Research on Neurocognition and Schizophrenia (TURNS), or Treatment and Evaluation Network for Trials in Schizophrenia (TENETS).

Methods of detecting fraud by a participant in a clinical trial are described, e.g., in U.S. Pat. No. 7,415,447 and U.S. Patent Application Publication No. 20110176712. Methods for detecting medical fraud are described, e.g., in U.S. Patent Application No. 20070174252.

Selection of Data Collection Sites

In another aspect, provided herein are methods, devices, systems, and computer readable medium for generating a site quality index, e.g., for a site that generates and/or collects data (e.g., medical data, e.g., psychological data, e.g., neurocognitive data). A site can a study site; e.g., a professional or academic site. A site can focus solely on collecting data, or collecting data can be one of several aspects of the functions of a site. The quality of a site that generates and/or collects data (e.g., neurocognitive data) can vary considerably. There can be variation in productivity (e.g., recruitment for a study, e.g., a clinical trial) among sites. There can be variation in data quality (e.g., there can be errors in data) and data sensitivity to treatment or placebo effects (e.g., the tendency to produce a large placebo response among subjects recruited and tested at one site compared to one or more other sites). Site effects in data, e.g., clinical data, can be a source of noise and bias in clinical trials. Selecting research sites that are likely to be able to collect high quality data (e.g., neurocognitive data) can be a consideration in the execution of drug development programs trying to develop new therapies for a variety of conditions, e.g., disorders affecting cognition. A site quality index can be used to determine sites that are likely to be able to collect high quality data, e.g., neurocognitive data.

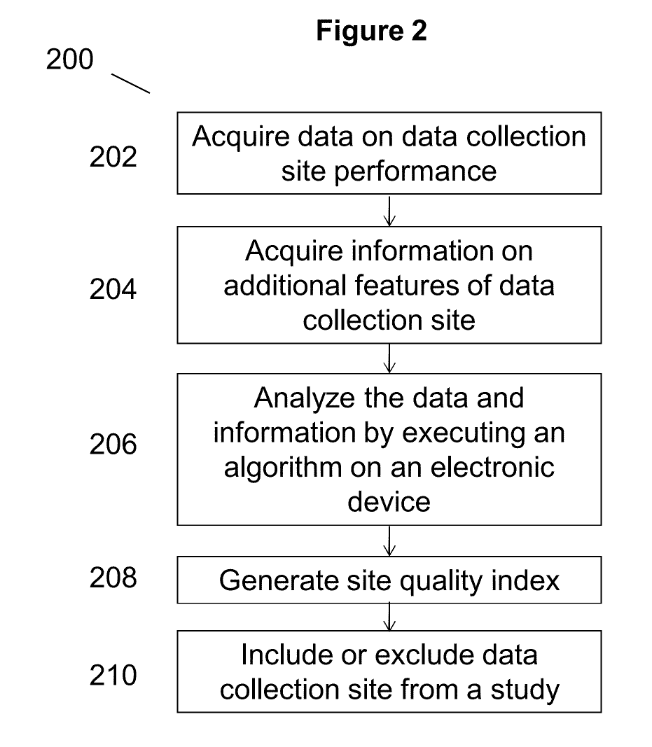

In one aspect, a method of evaluating one or more data collection sites (e.g., one or more sites that conduct a study) is provided. FIG. 2 illustrates an embodiment of such a method (200). The method can comprise obtaining data concerning the performance of the one or more data collection sites in conducting one or more studies (202). The method can comprise obtaining information regarding one or more additional features of the one or more data collection sites (204). The method can comprise analyzing the information and data, wherein the analyzing can comprise execution of an algorithm on an electronic device (206). The method can comprise generating a site quality index based on the analyzing (208). The site quality index can provide an indication of the quality of the one or more data collection sites. Additional steps can be performed as described herein.

In other aspects, a device or apparatus for evaluating one or more data collection sites is provided. The device can be, e.g., an electronic device, e.g., a computer. Additional examples of suitable electronic devices are described herein.

In another aspect, a system for evaluating one or more data collection sites is provided. The system can comprise computer readable instructions for obtaining data concerning the performance of the one or more data collection sites in conducting one or more studies and/or for obtaining information regarding one or more additional features of the one or more data collection sites. The system can comprise computer readable instructions for analyzing the information and data. The system can comprise computer readable instructions for generating a site quality index. The system can comprise computer readable instructions for performing additional steps.

In another aspect, a non-transitory computer readable medium is provided for evaluating one or more data collection sites. The non-transitory computer readable medium can have stored thereon sequences of instructions, which, when executed by a computer system, cause the computer system to perform obtaining data concerning the performance of the one or more data collection sites in conducting one or more studies and/or obtaining information regarding one or more additional features of the one or more data collection sites; analyzing the information and data; and generating a site quality index.

Site Quality Index

Information can be obtained from a data collection site to help characterize the site along a number of dimensions. For example, the information can comprise the setting (e.g., type of facility) of the one or more data collection sites. In some embodiments, the setting of the one or more data collection sites comprises an academic setting (e.g., academic laboratory, academic hospital) and/or professional setting (e.g., corporation or business). In some embodiments, the site is an acute care site. In some embodiments, an acute care site can be, e.g., an ambulatory care facility, and ambulatory surgery facility, a birth center, a chronic hemodialysis facility, a comprehensive outpatient rehabilitation facility, a comprehensive rehabilitation hospital, a computerized axial tomography (CAT) facility, a drug abuse treatment facility, an extracorporeal shock wave lithotripsy facility, a family planning facility, a family planning satellite office, a general acute care hospital, a home health agency, a hospice branch, a hospice care program, a general acute care hospital, a hospital-base, off-site ambulatory care facility, a magnetic resonance imaging (MRI) facility, a maternal and child health consortium, a megavoltage radiation oncology services facility, a positron emission tomography (PET) facility, a primary care facility, a primary care satellite office, a psychiatric hospital, or a satellite emergency department (SED). In some embodiments, the site is a long-term care facility. In some embodiments, the long-term care facility is an adult day care health services facility, alternate family care facility, assisted living program, assisted living residence, behavioral management program, comprehensive personal care home, hemodialysis facility, long term care hospital, long term care (pediatric), nursing home, pediatric day health care services, residential health care facility, or special hospital.

In some embodiments, the information is the identity of one or more principal investigators at the one or more data collection sites.

In some embodiments, the information is information about one or more raters (e.g., a rater of a neurocognitive assessment) at one or more data collection sites. In some embodiments, the information is the number of neurocognitive raters at the one or more data collection sites. In some embodiments, the information is the level or extent of experience of one or more neurocognitive raters at the one or more data collection sites. In some embodiments, the experience is expressed in terms of years of experience per rater on average at a site. For example, the experience can be about, or at least about 1, 5, 7, 10, 12, 15, 17, 20, 22, or years of experience on average per rater. In some embodiments, the experience of raters at the one or more data collection sites comprises experience with pasts tests used in one or more previous clinical trials. In some embodiments, the experience of raters at the one or more data collection sites comprises experience with one or more neurocognitive batteries used in a study, e.g., clinical trial.

In some embodiments, the information comprises the number of different types of tests administered at a site; e.g., about, or more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 different tests. In some embodiments, the information is the number of subjects observed at the one or more data collection sites. For example, the number of subjects can be about, or more than about 10, 50, 100, 200, 300, 400, 500, 600, 700, 800, 900, 1000, 5000, 10,000, 50,000, or 100,000. In some embodiments, the number of subjects is about 10 to about 100, about 100 to about 500, about 500 to about 1000, about 1000 to about 10,000, about 10,000 to about 50,000, or about 50,000 to about 100,000. In some embodiments, the information is the past enrollment performance in previous studies at the one or more data collection sites.

A database can be created for data collection sites based on the past performance of a site in a previous study, e.g., a previous clinical trial, e.g., a previous neurocognitive clinical trial. The database can comprise a variety of parameters. In some embodiments, the past performance comprises the number of neurocognitive administration errors in a study at the one or more data collection sites. The number of errors can be about, less than about, at least about, or more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 200, 300, 400, 500, 600, 700, 800, 900, 1000, 2000, 3000, 4000, 5000, 6000, 7000, 8000, 9000, or 10,000 different errors. In some embodiments, the past performance comprises the timing of one or more administration errors in a study at the one or more data collection sites. In some embodiments, the timing is early in a study and/or late in a study. In some embodiments, the timing is in the first quarter of a study, second quarter of a study, third quarter of a study, or fourth quarter of a study. In some embodiments, the timing is Phase 1, Phase 2, or Phase 3 of a clinical trial. In some embodiments, the past performance comprises one or more types of administration errors produced by neurocognitive raters at the one or more data collection sites.

In some embodiments, the past performance comprises a number of scoring errors produced by neurocognitive raters at the one or more data collection sites. In some embodiments, the past performance comprises the timing of one or more scoring errors produced by neurocognitive raters at one or more data collection sites. In some embodiments, the past performance comprises type of scoring errors produced at one or more data collection sites.

In some embodiments, the past performance comprises a magnitude of a placebo response at the one or more data collection sites. The magnitude of a placebo response can be a change from baseline among subjects enrolled in a placebo group. In some embodiments, the past performance is the magnitude of a placebo response separation from an active treatment group response. In some embodiments, the past performance is a comparison of a magnitude of a first placebo response at a first data collection site to a magnitude of a second placebo response at a second data collection site. In some embodiments, the first placebo response and second placebo response are from the same study. In other embodiments, the first placebo response and second placebo response are from different studies.

In some embodiments, the past performance comprises one or more occurrences of fraud at the one or more data collection sites. In some embodiments, the one or more occurrences of fraud at the one or more research sites comprise the manufacture of neurocognitive data on the part of staff in the absence of administering some or all of a neurocognitive test battery to a subject.

One or more of the above pieces of information and data can be used to generate a site quality index. A site quality index can be derived from a variety of different analysis. For example, in some embodiments, a site quality index is determined by rank ordering data collection sites to classify sites along a continuum of performance. In some embodiments, the performance comprises errors involving misapplication of discontinuation rules. Errors in mis-application of discontinuation rules can produce estimates of functioning (e.g., cognitive functioning) that are more biased than simple arithmetic errors in scoring (see e.g., Example 1).

In some embodiments, the site quality index is based on an unweighted or weighted metric. The unweighted or weighted metric can be based on parameters described above regarding a site's past performance. In some embodiments, errors are differentially weighted by their propensity to introduce error and bias into data. In some embodiments, the unweighted site quality index is derived from the formula:

Site Quality Index=[(Σᵢ₌₁^{N}Administration Errorsᵢ)+(Σᵢ₌₁^{N}Scoring Errorsᵢ)+(Σᵢ₌₁^{N}Number of T−score subscore changesᵢΣᵢ₌₁^{N}Scoring Errorsᵢ)+(Σᵢ₌₁^{N}Number of T−score composite changesᵢ)Σᵢ₌₁^{N}Number of T−score composite changesᵢ]/# Administrations of the measures.

In some embodiments, the weighted site quality index is derived from the formula:

Site Quality Index=[(Σᵢ₌₁^{N}(Administration Errorsᵢ))+(Σᵢ₌₁^{N}Scoring ErrorsᵢΣᵢ₌₁^{N}Administration Errorsᵢ)+(Σᵢ₌₁^{N}Magnitude of T−score subscore changesᵢΣᵢ₌₁^{N}Scoring Errorsᵢ)+(Σᵢ₌₁^{N}Magnitude of T−score composite changesᵢ)Σᵢ₌₁^{N}Number of T−score composite changesᵢ]# Administrations of the measures.

In the formula immediately above, the formula has been weighted in two respects. First, administration errors are counted as 3 times greater than other types of errors. Second, the magnitude of T-score changes is taken into account, not simply the number of them. An algorithm can also use a variety of mathematical techniques to uncover latent variables, which can be used to derive a site quality index.

Studies

Provided herein are methods, devices, systems, and computer readable medium for conducting a studying using a site quality index, e.g., for a site that generates and/or collects data, e.g., neurocognitive data. A site quality index can be used to include or exclude a data collection site from a study, e.g., a clinical trial. In one aspect, a method of performing a study is provided. FIG. 2 illustrates an embodiment of a method. The method can comprise obtaining data concerning the performance of one or more data collection sites in conducting one or more studies (202). The method can comprise obtaining information regarding one or more additional features of the one or more data collection sites (204). The method can comprise analyzing the information and data, wherein the analyzing comprises executing an algorithm on an electronic device (206). The method can comprise generating a site quality index based on the analyzing (208). The site quality index can provide an indication of the quality of the one or more data collection sites. The method can comprise selecting or excluding one or more data collection sites from a study based on the site quality index (210).

The study can be a research or clinical study, including any type of study described herein, e.g., a neurocognitive study. The study can be of any condition described herein, e.g., bipolar disorder, schizophrenia, or Alzheimer's disease.

In some embodiments, the one or more data collection sites comprise one or more neurocognitive data collection sites. In some embodiments, the one or more data collection sites are in one or more drug development programs.

A site quality index that is determined can be conveyed to a pharmaceutical or other sponsor of a clinical research trial. A decision can be made based on the site quality index regarding which one or more sites to recruit for a clinical trial.

Data Outlier Detection and Correction

Provided herein are methods, devices, systems, and computer readable medium for determining a data outlier index, e.g., for outlier data in a set of data, e.g., neurocognitive data. Outlier data can be a source of noise in a study, e.g., a clinical trial, and can potentially obscure differences between treatment groups. Elimination of outlier data can provide value to a sponsor of a clinical trial or clinical research by establishing that the data captured as part of a drug development program reflects the most representative profile of a subject's cognitive functioning. Outlier data can also be a source of bias in clinical assessments of a subject's cognitive functioning. For example, errors can lead to either false positive or false negative errors in terms of a subject meeting a diagnostic or other treatment-related threshold regarding his or her cognitive functioning.

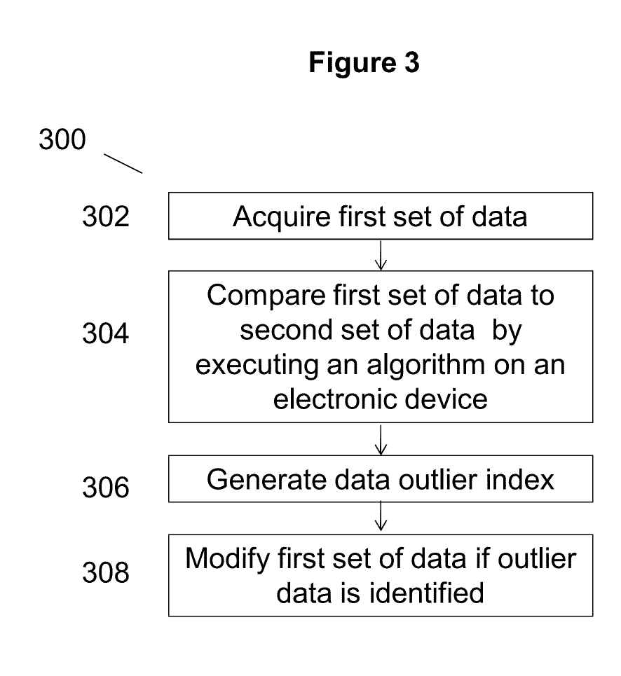

In one aspect, a method for determining whether data in one or more first data (e.g., a first set of data) from a subject in a study is aberrant is provided. FIG. 3 illustrates an embodiment of a method (300). The method can comprise acquiring one or more first data, wherein the one or more first data comprises one or more responses to one or more assessments administered to a subject (302). The method can comprise comparing the one or more first data to one or more second data (e.g., a second set of data), wherein the comparing comprises executing an algorithm on an electronic device (304). The method can comprise determining a data outlier index based on the comparing (306). The data outlier index can be a probability that one or more data in the first set of data is aberrant and an indication that one or more data are outlier data. Additional steps can be performed as described herein.

In other aspects, a device or apparatus for determining a data outlier index is provided. The device can be, e.g., an electronic device, e.g., a computer. Additional examples of suitable electronic devices are described herein.

In another aspect, a system for determining a data outlier index is provided. The system can comprise computer readable instructions for acquiring one or more first data, wherein the one or more first data comprises one or more responses to one or more assessments administered to a subject; comparing the one or more first data to one or more second data (e.g., a second set of data); and determining a data outlier index based on the comparing.

In another aspect, a non-transitory computer readable medium is provided for determining a data outlier index is provided. The non-transitory computer readable medium can have stored thereon sequences of instructions, which, when executed by a computer system, cause the computer system to perform acquiring one or more first data, wherein the one or more first data comprises one or more responses to one or more assessments administered to a subject; comparing the one or more first data to one or more second data (e.g., a second set of data); and determining a data outlier index based on the comparing.

Data Outlier Index

A data outlier index can reflect the probability that a recorded value is aberrant and should be either corrected or disregarded for the purpose of hypothesis testing in a study, e.g., a clinical trial.

The data outlier index can comprise comparing one or more first data (e.g., a first set of neurocognitive data) to one or more second data (e.g., a second set of neurocognitive data). The one or more first data and/or one or more second data can have characteristics as described herein.

The probability that one or more data (e.g., an observed score) is an outlier can be determined based on one or more criteria. For example, the data outlier index can be based on a statistical improbability (e.g., >3 standard deviations from the mean based on a comparator group). The statistical improbability can be based on a single score from a test (e.g., neurocognitive assessment) as compared to a historic database of responses from other patients or controls. In some embodiments, the statistical improbability can be based on a pattern of responses (e.g., in contrast to a single score; e.g., very low cognitive functioning on 4 subtests but very high functioning on 1 subtest) across a number of items or subtests in a test (e.g., a neurocognitive test battery) as compared to a historic database of responses from other patients or controls.

In some embodiments, the data outlier index is based on a clinical profile improbability. In some embodiments, the clinical profile improbability is based on a high correlation among multiple subtests, e.g., in the second set of data. In some embodiments, a large change on an individual neurocognitive test has a low probability if it occurs in isolation, as many facets of cognitive functioning can be correlated with one another. In some embodiments, the subject has a condition, and the subject is being treated for the condition, and the clinical profile improbability is based on a specific pattern of cognitive deficits associated with the condition being treated. The condition can be any condition described herein, including, e.g., bipolar disorder, schizophrenia, or Alzheimer's disease. In some embodiments, the clinical profile improbability is based on the rate of change of a cognitive parameter, e.g., in a first set of neurocognitive data compared to the second set of neurocognitive data. In some embodiments, the rate of change of a cognitive parameter, e.g., in the first set of neurocognitive data, is accelerated relative to the rate of change of the cognitive parameter in the second set of neurocognitive data. In some embodiments, a high rate of change of a cognitive parameter is indicative of outlier data.

In some embodiments, the comparing comprises comparing a single score in the first set of neurocognitive data to a single score in the second set of neurocognitive data. In some embodiments, the comparing comprises comparing a change in scores in the first set of neurocognitive data to a change of scores in the second set of neurocognitive data. For example, comparisons can be made between data from a patient at time 2 and time 1.

In some embodiments, the data outlier index is an unweighted metric. In some embodiments, the data outlier index is a weighted metric. In some embodiments, the weighted metric is based on parameters described above regarding data (e.g., a score) and its relationship to normative data, past performance by a subject on previous neurocognitive test administration, or other factors. In some embodiments, a characteristic of data (e.g., a score) can be differentially weighted by a probable relationship to whether the data (e.g., score) is the result of valid neurocognitive functioning or rather some type of administration or scoring error. In some embodiments, the weighted metric is based on a comparison between the first set of data and the second set of data. In some embodiments, the first set of data and the second set of data are from the same subject. In some embodiments, the second set of data is a database of historical scores from assessments of other subjects.

In some embodiments, the data outlier index is derived from a formula, wherein the formula is: data outlier index=(statistical threshold metric)+(across subtest comparison metric)+(across patient metric). In some embodiments, the data outlier index has a sample range of 0-3. In some embodiments, the statistical threshold metric equals 0 if a score, e.g., in the first set of neurocognitive data, is less than 3 standard deviations from the mean of a score, e.g., in the second set of neurocognitive data (e.g., healthy normative data), and wherein the statistical threshold metric equals 1 if a score, e.g., in the first set of data, is greater than or equal to 3 standard deviations from a score, e.g., in the second set of data (e.g., healthy normative data). In some embodiments, the second set of data comprises healthy normative data. In some embodiments, the across subtest comparison metric is 1 if the difference of a subtest score, e.g., in a first set of data, to an overall composite score on other subtests, e.g., in the first set of data is greater than 15 T-score points, and the across subtest comparison metric is 0 otherwise. In some embodiments, the across-patient metric is 1 if a subject's raw score, e.g., in the first set of data, is greater than 3 standard deviations from the mean raw score from all other subject's scores, e.g., in a second set of data, on that subtest at a visit, and the across-patient metric is zero otherwise.

In some embodiments, implementation of an algorithm can use a variety of mathematical techniques, including, e.g., data mining, to uncover one or more latent variables, which could be used to derive a data outlier index.

Action

One or more actions can be taken based on the data outlier index. In some embodiments, the one or more first data is modified. The modification can be, e.g., a correction, amendment, recalculation, addition of data to the first data set, removal of data from the first data set, or exclusion of data from the first set of data from further analysis. Data can be excluded if inclusion of aberrant data in a study would lead to a bias when calculating a group mean for a subset of patients in a clinical trial (e.g., those subjects on the high dose of a study medication in a placebo-controlled clinical trial) or false positive or false negative errors for a subject meeting a diagnostic or treatment-related threshold regarding their cognitive function. Excluding data can enhance the overall quality of data by removing erroneous data, which can be measured by a variety of psychometric indexes, e.g., an intraclass correlation coefficient or other measures of test reliability. In some embodiments, clarification from a rater at the site who administered the neurocognitive assessment can be sought to determine if either administration or scoring of a test was in error. A corrected score can be entered into a database for analysis.

In some embodiments, imputing the data can be performed using any conventional statistical method of imputation.

Assessment

An assessment used in methods comprising a step of generating a data outlier index can comprise any assessment described herein. In some embodiments, an assessment comprises an error. In some embodiments, the error is an error in administration of an assessment, e.g., a neurocognitive assessment. In some embodiments, the error is an error in scoring an assessment, e.g., a neurocognitive assessment.

Study

Provided herein are methods, devices, systems, and computer readable medium for performing a study making use of a data outlier index. In one aspect, a method for performing a study is provided. FIG. 3 illustrates an embodiment of a method (300). The method can comprise acquiring one or more first data (e.g., a first set of data) (302). The one or more first data can comprise one or more responses to one or more assessments administered to a subject. The method can comprise comparing the one or more first data to one or more second data (e.g., a second set of data), wherein the comparing comprises execution of an algorithm on an electronic device (304). The method can comprise determining a data outlier index based on the comparing (306). The data outlier index can be a probability that one or more data in the one or more first data is aberrant and an indication that the data is outlier data. The method can comprise modifying the first set of data if the data comprises outlier data (308).

The data can be modified as described herein. In some embodiments, the first set of data is modified if outlier data is not identified. In some embodiments, the second set of data is modified.

The study can be any study described herein.

Selecting Likely Responders to a Therapy

Provided herein are methods, devices, systems, and computer readable medium for determining a likely responder index, e.g., to a treatment. For many illnesses associated with neurocognitive impairment, by the time a disorder has become symptomatic, the brain can have undergone significant changes, both micro- and macroscopically. Thus, improving cognition pharmacologically in patients with these disorders can be difficult. Consequently, any ability to predict, a priori, which patients are most likely to benefit from an intervention can be of commercial interest (e.g., by enabling enrollment of only those subjects likely to show a response to a medication, the absolute numbers of patients exposed to novel therapies can be reduced while at the same time improving the odds of detecting a significant difference versus subjects in the placebo group) or clinical interest (e.g., by predicting likelihood of response to approved medicines).

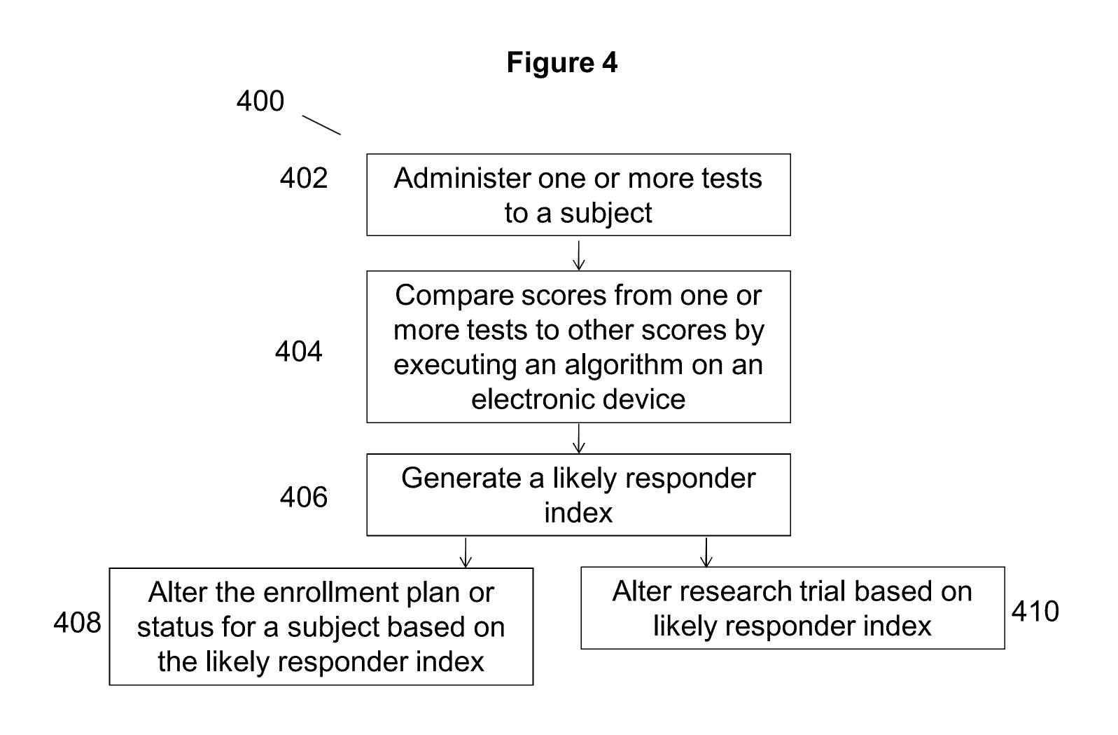

In one aspect, a method is provided for generating a responder index. FIG. 4 illustrates an embodiment of a method (400). The responder index can reflect the likelihood a subject will respond to one or more therapies or treatments for a condition. The method can comprise administering one or more tests to the subject (402). The method can comprise comparing the scores from the one or more tests to scores from the one or more tests from one or more other subjects (404). The method can comprise generating a responder index based on executing an algorithm on an electronic device (406). The responder index can quantify the probability that the subject will show an improvement by receiving one or more therapies or treatments. Additional steps can be performed as described herein.

In other aspects, a device or apparatus for generating a responder index is provided. The device can be, e.g., an electronic device, e.g., a computer. Additional examples of suitable electronic devices are described herein.

In another aspect, a system for generating a responder index is provided. The system can comprise computer readable instructions for administering one or more tests to the subject; comparing the scores from the one or more tests to scores from the one or more tests from one or more other subjects; and generating a responder index based on executing an algorithm.

In another aspect, a non-transitory computer readable medium is provided for generating a responder index. The non-transitory computer readable medium can have stored thereon sequences of instructions, which, when executed by a computer system, cause the computer system to perform administering one or more tests to the subject; comparing the scores from the one or more tests to scores from the one or more tests from one or more other subjects; and generating a responder index.

Responder Index

To generate a responder index, one or more tests, e.g., neurocognitive tests, can be administered to a subject. In some embodiments, the tests are centrally scored. In some embodiments, the tests are scored at independent sites. The scores from those tests can be compared to a database of data from other subjects. The comparison can be of performance relative to a database generated from a research or clinical setting, wherein neurocognitive, symptomatic, and/or pharmacogenomic profile of subjects who have previously been shown to be responsive to that therapy are identified.

The data (e.g., neurocognitive data) can be combined with other sources of information to provide a predictive index (e.g., maximally predictive index) reflecting the likelihood of responding to a particular therapy (e.g., an agent or pharmaceutical agent or non-pharmaceutical therapy). For example, the other sources of information can be functional capacity measures (e.g., the ability of improvements in specific areas of cognition to translate into meaningful improvements in a subject's ability to complete daily tasks, including activities of daily living, achieving employment, etc.).

A functional capacity measure can be, e.g., ability to feed oneself, care for oneself, bathe, manage finances, manage social interactions, obtain employment, retain employment, meet a deadline, follow instructions, etc.

In some embodiments, the other information comprises results of one or more pharmacogenomic tests. A pharmacogenomic test can comprise determining the presence or absence of a genetic variation, wherein a genetic variation can influence a response of a subject to a drug. The pharmacogenomic test can be, e.g., for a cytochrome P450 (CYP) gene (e.g., CYP2D6), DPD, UGT1A1, TMPT, and/or CDA.

In some embodiments, other sources of information include other predictive factors (e.g., smoking status if the pharmacotherapy is an agonist, co-agonist or otherwise modulates the alpha-7 nicotinic receptor either directly or indirectly). In some embodiments, the information is an lifestyle factor described herein, e.g., diet, exercise level, stress-level, amount of sleep, drug use, alcohol use, an nature of interpersonal relationships.

In some embodiments, based on the data outlined above, a responder index is created. The responder index can quantify the probability that a patient will show an improvement (e.g., a neurocognitive improvement) to a particular therapy or combination of therapies.

The responder index can be used to make a clinical decision (e.g., start a new therapy or make changes to an existing therapeutic regimen) or a research decision (e.g., enroll into a clinical trial or change the probability of being assigned to a certain condition within a clinical trial).

Determining Responders and Treatment

Provided herein are methods, devices, systems, and computer readable medium for treating a subject with a condition. FIG. 4 illustrates an embodiment of the method (400). The method can comprise administering one or more tests to the subject (402). The method can comprise comparing scores from the one or more tests to scores from the one or more tests from one or more other subjects (404). The method can comprise generating a responder index based on the comparing (406). The responder index can quantify the probability that the subject will show an improvement to one or more therapies. The responder index can be generated by executing an algorithm on an electronic device. The responder index can be compared to a threshold. A determination can be made whether the subject is a likely responder based on the responder index. In some embodiments, the subject can be treated based on determining whether the subject is a likely responder In some cases, an enrollment plan or status for a subject can be altered based on the likely responder index (408). In other embodiments, a research decision can be made based on the likely responder index (e.g., enroll a subject in a clinical trial) (410).

Treatment and/or Therapies

In some embodiments, a treatment or therapy comprises administration of one or more pharmaceutical agents to a subject. The one or more pharmaceutical agents can be administered separately or in the same composition. The one or more pharmaceutical agents can be administered to a subject over a period of hours, days, weeks, months, years, or decades. The one or more pharmaceutical agents can be self administered to a subject or administered by another person or a machine to a subject.

A pharmaceutical agent that can be provided to a subject can include, e.g., a selective serotonin reuptake inhibitor (SSRI), e.g., citalopram (CELEXA®), escitalopram (LEXAPRO®, Cipralex), paroxetine (PAXIL®, Seroxat), fluorexetine (PROZAC®), fluvoxamine (LUVOX®), sertraline (ZOLOFT®, Lustral); a serotontin-norepinephrine reuptake inhibitor (SNRI), e.g., desvenlafaxine (PRISTIQ®), duloxetine (CYMBALTA®), milnacipran (Ixel, Savella), venlafaxine (EFFEXOR®), tramadol (Tramal, Ultram) or sibutramine (meridian, reductil); a serotonin antagonist and reuptake inhibitor (SARI), e.g., etoperidone (Axiomin, Etonin), lubazodone (YM-992, YM-35,995), nefazodone (serzone, nefadar), or trazodone (DESYREL®); a norespinephrine reuptake inhibitor (NRI), e.g., reboxetine (Edronax), veloxazine (Vivalan), atomoxetine (strattera); a norepinephrine-dopamine reuptake inhibitor (NDRI), e.g., bupropion (WELLBUTRIN®, Zyban), dexmethylphenidate (FOCALIN®), methylphenidate (Ritalin, Concerta); a norepinephrine-dopamine releasing agent (NDRA), e.g., amphetamine (Adderall), dextroamphetamine (Dexedrine), dextromethamphetamine (Desoxyn), lisdexamfetamine (Vyvanse); a tricyclic antidepressant (TCA), e.g., amitriptyline (ELAVIL®, Endep), clomipramine (ANAFRANIL®), desipramine (NORPRAMIN®, Pertofrane), dosulepin (Dothiepin, Prothiaden), doxepin (Adapin, SINEQUAN®), imipramine (TOFRANIL®), lofepramine (Feprapax, Gamanil, Lomont), nortriptyline (PAMELOR®), protriptyline (VIVACTIL®), trimipramine (SURMONTIL®); a tetracyclic antidepressant (TeCA), e.g., amoxapine (ASENDIN®), maprotiline (LUDIOMIL®), mianserin (Bolvidon, Norval, Tolvon), mirtazapine (REMERON®); or a monoamine oxidase inhibitor (MAOI), e.g., isocarboxazid (MARPLAN®), moclobemide (Aurorix, Manerix), phenelzine (NARDIL®), selegiline (L-Deprenyl, Elderpryl, Zelapar, EMSAM®), tranylcypromine (PARNATE®), or pirlindole (Pirazidol).

Other examples of pharmaceutical agents that can be provided to a subject include, e.g., a 5-HT1A receptor agonist, e.g., buspirone (BUSPAR®), tandospirone (Sediel), aripiprazole (Abilify), vilazodone (Viibryd), or quetiapine XR (Seroquel XR); a 5-HT2 receptor agonist, e.g., aripiprazole (Abilify); a 5-HT2 receptor antagonist, e.g., agomelatine (Valdoxan), nefazondone (Nefadar, Serzone), quetiapine XR (Seroquel XR); a 5-HT7 receptor antagonist, e.g., aripiprazole (Abilify), quetiapine XR (Seroquel XR); a D2 receptor partial agonist, e.g., aripiprazole (Abilify); a D2 receptor antagonist, e.g., quetiapine XR (Seroquel XR); a D3 receptor antagonist, e.g., aripiprazole (Abilify); a D4 receptor antagonist, e.g., aripiprazole (Abilify); an alpha-adrenergic receptor antagonist, e.g., aripiprazole (Abilify), quetiapine XR (Seroquel XR); an mACh receptor antagonist, e.g., aripiprazole (Abilify), quetiapine XR (seroquel XR); a sertotonin reuptake inhibitor (SRI), e.g., aripiprazole (Abilify), Vilazodone (Viibryd); a norepinephre reuptake inhibitor (NRI), e.g., quetiapine XR (seroquel XR); a selective serotonin reuptake enhancers (SSREs), e.g., tianeptine; a sigma receptor agonist, e.g., opipramol (Insidon, Pramolan); or a mood stabilizer, e.g., carbamezepine (TEGRETOL®), lamotrigine (LAMICTAL®), lithium (ESKALITH®, Lithan, LITHOBID®), valproic acid (DEPAKENE, STAVZOR), sodium valproate (EPILIM), or divalproex sodium (DEPAKOTE®).

The pharmaceutical agent can be an agent used to treat Alzheimer's disease. For example, the pharmaceutical agent can be RAZADYNE® (galantamine, a cholinesterase inhibitor), EXELON® (rivastigmine, a cholinesterase inhibitor), ARICEPT® (donepezil, a cholinesterase inhibitor), COGNEX® (tracine, a cholinesterase inhibitor), or NAMENDA® (memantine, an N-methyl D-asparate (NMDA) antagonist).

The pharmaceutical agent can be an agent used to treat schizophrenia, e.g., chlorpromazine (THORAZINE®), haloperidol (HALDOL®), perphenazine, fluphenzaine, clozapine (CLOZARIL®), risperidone (RISPERDALC), olanzapine (ZYPREXIA®), quetiapine (SEROQUEL®), ziprasidone (GEODON®), aripiprazole (Abilify), or paliperidone (INVEGA®).

The pharmaceutical agent can be, e.g., a combination antipsychotic and antidepressant medication, e.g., Symbyax (PROZAC® and Zyprexa) (fluoxetine and olanzapine).

The pharmaceutical agent can be, e.g., FANAPT® (iloperidone), LOXITANE® (loxapine), MOBAN® (molindone), NAVANE® (thiothixene), ° RAP® (pimozide), STELAZINE® (triluoperazine), thioridzine, AVENTYL® (nortiptyline), PEXEVA® (paroxetine-mesylate), TROFRANIL-PM® (impramine pamoate), NEUROTIN® (gabapentin), TOPAMAX® (topiramate), or TRILEPTAL® (oxcarbazepine).

The pharmaceutical agent can be an anti-anxiety medication, e.g., ATIVAN® (lorazepam), BUSPAR® (buspirone), KLONOPIN® (clonazepam), LIBRIUM® (chlordiazepoxide), oxazepam, TRANXENE® (chlorazepate), VALIUM® (diazepam), or XANAX® (alprazolam).

The pharmaceutical agent can be an ADHD medication, e.g., ADDERALL® (amphetamine), ADDERALL® XR (amphetamine extended release), CONCERTA® (methylpehidate (long acting)), DAYTRANA® (methylphenidate patch), DESOXYN® (methamphetamine) DEXEDRINE® (dextroamphetamine), FOCALIN® (dexmethylphenidate), FOCALIN® XR (dexmethylphenidate extended release), INTUNIV® (guanfacine), METADATE® ER (methylphenidate extended release), METADATE CD (methylphenidate extended release), METHYLIN® (methlphenidate (oral solution and chewable tablets)), RITALIN® (methylphenidate), RITALIN® SR (methylphenidate SR), RITALIN® LA (methylphenidate (long-acting)), STATTERA® (atomoxetine), or VYVANSE® (lisdexamfetamine dimesylate).

In some cases, a pharmaceutical agent can be AMBIEN® (zolpidem), AMBIEN CR® (zolpidem tartrate extended-release) tablets, ANTABUSE (disulfiram), ANAFRANIL (clomipramine), benperidol, a benzodiazepine, CYMBALTA® (duloxetine), NARDIL® (phenelzine), GABITRIL® (tiagabine), INDERAL® (propanolol), KEPPRA® (levetiracetam), LEXAPRO® (escitalopram), LUNESTA® (eszopiclone), MELLARIL® (thioridazine), NEUONTIN (gabapentin), PROLIXIN® (fluphenazine), PROVIGIL® (modafinil), REMINYL® (galantamine), RESTORIL® (temazepam), REVIA® (naltrexone), SERAX® (oxazepam), STRATTERA® (atomoxetine), THORAZINE® (chlorpromazine), VISTARIL® (hydroxyzine), WELLBUTRIN® (bupropion), SONATA® (zaleplon), or IMOVANE (zopiclone).

In some cases, a pharmaceutical agent can be a bipolar mood stabilizer, e.g., ESKALITH (lithium carbonate), LITHONATE (lithium carbonate), DEPAKOTE (divalproex sodium), GABATRIL (tiagabine), KEPPRA (levetiracetam), LAMITCAL (lamotrigine), NEURONTIN (gabapentin), TEGRETOL (carbamazepine), TRILEPTAL (oxcarbazepine), TOPAMAX (topiramate), ZONEGRAN (zonisamide), ZYPREXA (olanzapine), CALAN (verapamil), CATAPRES (clonidine), INDERAL (propranolol), MEXITIL (mexiletine), or TENEX (guanfacine).

In some embodiments, a treatment or therapy does not comprise a pharmaceutical agent. In some embodiments, a treatment or therapy comprises a psychotherapy. In some embodiments, the psychotherapy is psychoanalytic, behavior therapy, applied behavior analysis, cognitive behavioral (CBT), psychodynamic, existential, humanistic, systemic, transpersonal, psychospiritual, or body psychotherapy (body-oriented psychotherapy, somatic psychology). In some embodiments, the therapy comprises psychoanalysis, Gestalt Therapy, group psychotherapy, expressive therapy, interpersonal psychotherapy, narrative therapy, integrative psychotherapy, hypotherapy (hypnosis), or metapsychiatry. In some embodiments, CBT therapy is prescribed for a subject to treat depression, anxiety disorders, bipolar disorder, eating disorder, schizophrenia.

In some embodiments, the therapy is dialectical behavior therapy (DBT). DBT can be used to treat people with borderline personality disorder (BPD).

A cognitive therapy can focus on thoughts and how the thoughts affect emotions. Psychodynamic therapy can address internal conflicts and patterns of relating.

In some embodiments, the therapy is interpersonal therapy (IPT). IPT can be used to treat depression or dysthymia. In some embodiments, the therapy comprises social rhythm therapy (IPSRT), which can be used to treat bipolar disorder.

In some embodiments, the therapy is family-focused therapy (FFT). In some embodiments, the therapy can be psychodynamic therapy, light therapy, individual therapy, group therapy, expressive or creative arts therapy, animal-assisted therapy, or play therapy. The therapy can be a psychotherapy described at, e.g., www.nimh nih gov/health/topics/psychotherapies/index.shtml.

In some embodiments, the therapy is performed or administered by a practitioner with a background in, e.g., psychiatry, clinical psychology, counseling psychology, clinical or psychiatric social work, mental health counseling, marriage and family therapy, rehabilitation counseling, school counseling, play therapy, music therapy, art therapy, drama therapy, dance/movement therapy, occupational therapy, psychiatric nursing, or psychoanalysis. A therapy can be administered by, e.g., a psychiatrist, a psychologist, a clinical social worker, a psychiatric nurse, a marriage and family therapist, or a licensed professional counselor. A therapy can be administered by a male or a female.

The length of therapy a subject can receive, from the start of the therapy to the completion of therapy, can be days, weeks, months, years, or decades of therapy.

In some embodiments, a treatment comprises administering one or more non-pharmaceutical therapies to a subject. In some embodiments, a treatment comprises administering one or more pharmaceutical agents to a subject. In some embodiments, a treatment comprises administering one or more non-pharmaceutical therapies in conjunction with one or more pharmaceutical therapies to a subject.

In some embodiments, the therapy or treatment comprises deep brain stimulation for Parkinson's disease.

In some cases, a therapy is a CNS therapy involving a medical device, e.g., vagal nerve stimulation, deep brain stimulation, electroconvulsive therapy (ECT), cranial electrotherapy stimulation (CES), transcranial magnetic stimulation (TMS), repetitive transcranial magnetic stimulation, magnetic seizure therapy, or trigeminal nerve stimulation (TNS). A brain stimulation therapy can comprise activating or touching the brain with electricity, magnets, or implants.

Database

The database to which data from a subject can be compared can comprise any type of data described herein. The database can comprise neurocognitive, symptomatic, and/or pharmacogenomic profiles of subjects who have previously been shown to be responsive to a therapy. The database can comprise any information on one or more subjects described herein.

Placebo Responder Identification

In another aspect, provided herein are methods, devices, systems, and computer readable medium for determining a placebo responder index. Placebo response can be a problem in a study, e.g., a central nervous system (CNS) clinical trial. Being able to predict, a priori, which subject(s) are most likely to manifest a placebo response (e.g., a robust placebo response) can help to enhance the drug-placebo differences in clinical trials, thereby enhancing signal detection and allowing for smaller trials to be run, exposing fewer subjects to experimental medications, and reducing the overall costs to bring new drugs to market.

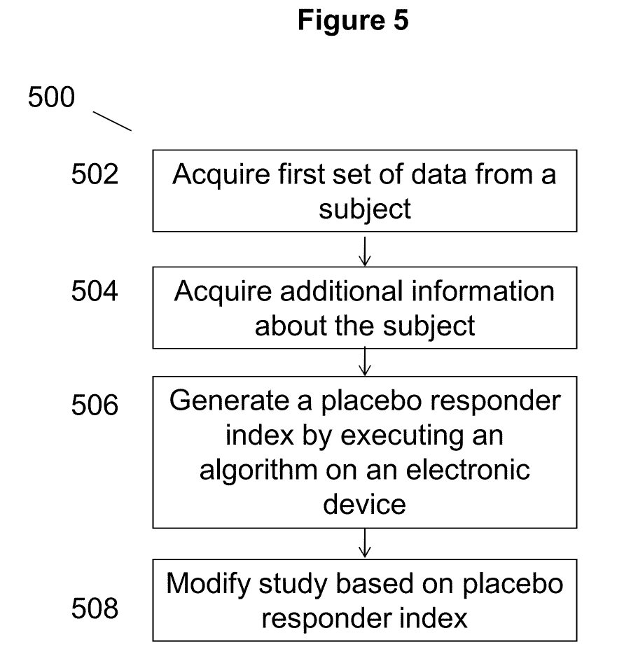

In one aspect, a method of generating a placebo responder index for a subject is provided. FIG. 5 illustrates an embodiment of a method (500). The method can comprise acquiring one or more first data (e.g., a first set of data), wherein the one or more first data comprise one or more responses to one or more assessments administered to a subject (502). The method can comprise acquiring additional information about the subject (504). The method can comprise generating a placebo responder index based on the one or more first data and the information (506). The placebo responder index can be generated by executing an algorithm on an electronic device. Additional steps can be performed as described herein.

In other aspects, a device or apparatus for generating a placebo responder index is provided. The device can be, e.g., an electronic device, e.g., a computer. Additional examples of suitable electronic devices are described herein.

In another aspect, a system for determining a placebo responder index is provided. The system can comprise computer readable instructions for acquiring one or more first data (e.g., a first set of data), wherein the one or more first data comprise one or more responses to one or more assessments administered to a subject; acquiring additional information about the subject; and generating a placebo responder index based on the one or more first data and the information.

In another aspect, a non-transitory computer readable medium for determining a placebo responder index is provided. The non-transitory computer readable medium can have stored thereon sequences of instructions, which, when executed by a computer system, cause the computer system to perform acquiring one or more first data (e.g., a first set of data), wherein the one or more first data comprise one or more responses to one or more assessments administered to a subject; acquiring additional information about the subject; and generating a placebo responder index based on the one or more first data and the information.

Placebo Responder Index

Data about a subject can be used to generate a placebo responder index. The data can be any type of data describe herein. For example, the data can be data from a completed neurocognitive test battery. The neurocognitive test battery can include a screening battery. The screening battery can help determine whether a subject is appropriate for inclusion into a trial.

Additional information about a subject can be used to determine a placebo responder index. The data can be any data described herein. The additional information can comprise data regarding a subject's symptoms, past treatment history, response to other psychological or physiological assessments.

Using data received about a subject, a placebo responder index can be created. The placebo responder index can be based on the subject's profile of neurocognitive, symptom, personality, or other types of available data. This profile can be compared to a database of indexes from other subjects who have participated in a previous study (e.g., clinical trial), as those other subjects have both profile data as well as placebo response data, thereby enabling a determination of which subject characteristics predict manifesting a robust placebo response.

One of a number of placebo responder index algorithms can be used. In one embodiment, a placebo responder index for a subject in a clinical trial of a therapy (e.g., pharmacotherapy) for cognitive impairments in schizophrenia is: Placebo Responder Index=(Difference between the baseline T-score on neurocognitive test A and the score on neurocognitive test A after 6 weeks of treatment)×(The percent improvement between baseline and Week 6 on a measure of their psychotic symptoms)

The implementation of such an algorithm can use a variety of parametric, nonparametric, data mining, and other mathematical techniques to uncover other potential (weighted or unweighted) combination of variables, including latent variables not directly measured by any one variable, which could be used to predict the probability and magnitude of a placebo response

In some embodiments, feedback regarding the placebo response index for the subject under consideration is provided, e.g., to a sponsor of a study.

Generation of a placebo responder index can comprise using methods and systems for identifying predisposition to a placebo effect as described, e.g., in U.S. Patent Publication NO. 20050079532. Generation of a placebo responder index can comprise use of methods described in U.S. Patent Application Publication No. 20100144781 (Methods of Treating Psychosis and Schizophrenia based on Polymorphisms in the ERBB4 Gene).

Studies

Provided herein are methods, devices, systems, and computer readable medium for performing a study making use of a placebo responder index. FIG. 5 illustrates one embodiment of a method (500). In one aspect, a method of performing a study for a condition is provided. The method can comprise acquiring one or more first data (e.g., a first set of data) (502), wherein the first set of data comprises one or more responses to one or more assessments administered to a subject. The method can comprise acquiring additional information about the subject (504). The method can comprise generating a placebo responder index based on the one or more first data (e.g., first set of data) and the information (506). The placebo responder index can be generated by executing an algorithm on an electronic device. The method can comprise modifying the study based on a likelihood the subject will respond to placebo (508). The modifying can be based on the likelihood the subject will respond to placebo. The modifying can comprise modifying the subject's enrollment or status in the study. The modifying can comprise changing a distribution allocation of subjects among different treatment groups.

A treatment or therapy for which a placebo responder index can be generated for a subject can be any treatment or therapy described herein.

Generating a Neurocognitive Battery

In another aspect, provided herein are methods, devices, systems, and computer readable medium for generating a neurocognitive battery. A neurocognitive battery can be lengthy to administer (including some that may take hours to complete), costing time and money to administer, score, and interpret. Some items in a neurocognitive battery may be unresponsive to changes that a subject manifests when undergoing a new therapy for his or her cognitive impairments. An empirically-derived truncated neuropsychological battery with items selected to be maximally sensitive to change induced by one or more therapies under study can be beneficial to a subject, patient, clinical staff, and a sponsor of the research.

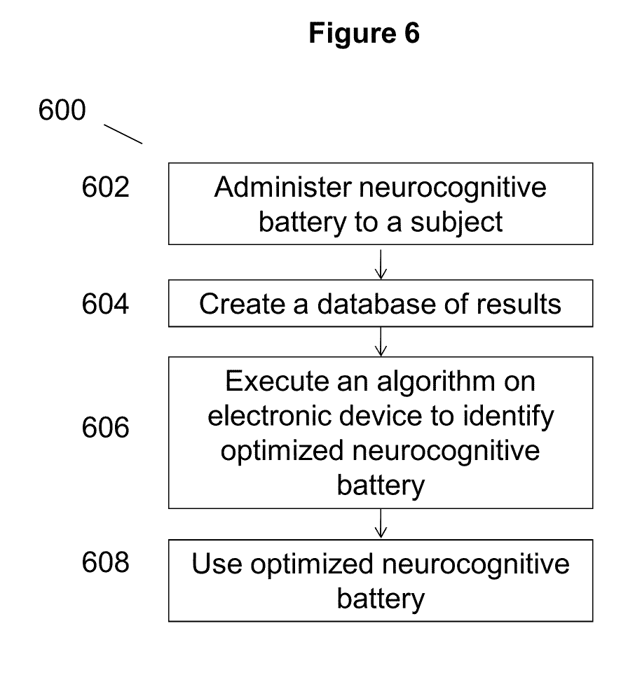

In one aspect, a method of generating a neurocognitive assessment is provided. FIG. 6 illustrates an embodiment of a method (600). The method can comprise administering one or more neurocognitive batteries to a plurality of subjects with a condition (602). The condition can be a neurocognitive condition. The method can comprise creating a database of results of the one or more neurocognitive batteries. The method can comprise analyzing the database by executing an algorithm on an electronic device (606). The method can comprise identifying an optimized neurocognitive battery based the analyzing. The truncated battery can be used in subsequent studies or can be applied to pre-existing data.

In other aspects, a device or apparatus for generating a neurocognitive assessment is provided. The device can be, e.g., an electronic device, e.g., a computer. Additional examples of suitable electronic devices are described herein.

In another aspect, a system for generating a neurocognitive assessment is provided. The system can comprise computer readable instructions for administering one or more neurocognitive batteries to a plurality of subjects with a condition; creating a database of results of the one or more neurocognitive batteries; analyzing the database; and identifying an optimized neurocognitive battery based the analyzing.

In another aspect, a non-transitory computer readable medium for generating a neurocognitive assessment is provided. The non-transitory computer readable medium can have stored thereon sequences of instructions, which, when executed by a computer system, cause the computer system to perform: administering one or more neurocognitive batteries to a plurality of subjects with a condition; creating a database of results of the one or more neurocognitive batteries; analyzing the database, and identifying an optimized neurocognitive battery based the analyzing.

The plurality of subjects can receive one or more therapies or treatments. The one or more therapies or treatments can be any therapy or treatment described herein. The plurality of subjects can have a cognitive impairment associated with a condition, e.g., a neurocognitive condition. The neurocognitive condition can be any neurocognitive condition described herein. The plurality of subjects can receive one or more therapies or treatments for one or more cognitive impairments associated with one or more conditions.

Any of a number of computational approaches can be used to reduce the total number of test items (e.g., neurocognitive test items) to a subset of stimuli or questions that are maximally sensitive to the intervention under study or being considered for clinical use. The computational approaches can include item response theory, Rasch analysis, exploratory factor analysis, stepwise regression, principal component analysis, or other computational approaches.

In some embodiments, the number of test items in a truncated battery is reduced by about, less than about, more than about, or at least about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% relative to a corresponding “untruncated” battery. In some embodiments, the number of test items in a truncated battery is reduced by about, less than about, more than about, or at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 items relative to a corresponding “untruncated” battery.

In some embodiments, the sensitivity of a truncated battery relative to a corresponding “untruncated” battery is increased by about, at least about, or more than about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100%, 125%, 150%, 175%, 200%, 300%, 400%, 500%, 600%, 700%, 800%, 900%, 1000%, 5000%, or 10,000%. In some embodiments, the sensitivity of a truncated battery relative to a corresponding “untruncated” battery is increased by about, at least about, or more than about 0.1 fold, 0.2 fold, 0.3 fold, 0.4 fold, 0.5 fold, 0.6 fold, 0.7 fold, 0.8 fold, 0.9 fold, 1 fold, 2 fold, 3 fold, 4 fold, 5 fold, 6 fold, 7 fold, 8 fold, 9 fold, 10 fold, 20 fold, 30 fold, 40 fold, 50 fold, 60 fold, 70 fold, 80 fold, 90 fold, or 100 fold.

A truncated (optimized) neurocognitive battery can be applied to further studies or pre-existing databases from other trials to confirm its ability to enhance signal detection (e.g., the ability to show a difference between an effective treatment and placebo). For example, the optimized neurocognitive battery can be applied to a future clinical study. The optimized neurocognitive battery can be applied to a pre-existing database of a clinical trial data to confirm the ability of the optimized neurocognitive battery to enhance signal detection in a clinical trial. For example, responses to questions that are absent in a truncated battery but are present in a corresponding “untruncated” battery can be removed from a set of data generated by administering the “untruncated” battery, and the data with the eliminated responses can be evaluated.

A truncated battery can be administered to a subject with a condition or a subject suspected of having a condition, or a symptom. The subject can be any type of subject described herein. The condition or symptom can be any condition or symptom described herein, including a neurocognitive condition. A neurocognitive condition can comprise Alzheimer's disease, bipolar disorder, schizophrenia, or any neurocognitive condition described herein.

A truncated battery can be administered to a subject receiving any type of therapy or treatment described herein.

A neurocognitive battery that can be truncated can be any neurocognitive battery described herein. Any battery or neurocognitive battery described herein can be optimized using the methods, devices, systems, or computer readable medium described herein.

An algorithm for generating a truncated neurocognitive battery can be executed on an electronic device, e.g., a computer, or any electronic device described herein.

Subjects

A subject as indicated herein can be, e.g., a mammal The mammal can be, e.g., a primate. The primate can be a primate of the Hominidae family. The primate of the Hominidae family can be, e.g., a human. The primate can be, e.g., a common chimpanzee (Pan troglodytes), a bonobo or pygmy chimpanzee (Pan paniscus), a gorilla (e.g., Western gorilla (Gorilla gorilla) or Eastern gorilla (Gorilla berignei)), a Bornean orangutan (Pongo pygmaeus), or Sumatran orangutan (Pongo abelii). The mammal can be, e.g., a rodent, e.g., mouse or a rat. The mammal can be a cat, dog, horse, cow, donkey, or rabbit.

The human can be, e.g., a preterm newborn, a full term newborn, an infant up to one year of age, young children (about 1 year old to about 12 years old), a teenager (about 13 years old to about 19 years old), an adult (about 20 years old to about 64 years old), a pregnant woman, or an elderly adult (about 65 years old and older).

The age of the subject can be about, less than about, at least about, or more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, or 110 years old. The age of the subject can be about 1.5 year old to about 5 years old, about 6 years old to about 18 years old, about 11 years old to about 18 years old, about 5 years old to about 13 years old, about 3 years old to about 18 years old, about 4 years old to about 18 years old, about 11 years old to about 19 years old, about 12 years old to about 19 years old, about 5 years old to about 18 years old, about 16 years old to about 69 years old, about 6 years old to about 11 years old, about 18 years old to about 65 years old, about 17 years old to about 80 years old, about 7 years old to about 14 years old, about 6 years old to about 69 years old, about 5 years old to about 91 years old, about 5 years old to about 16 years old, about 15 years old to about 80 years old, about 65 years old to about 81 years old, about 20 years old to about 80 years old, about 2 years old to about 12 years old, about 2 years old to about 80 years old, about 70 years old to about 90 years old, about 5 years old to about 89 years old, about 16 years old to about 92 years old, about 8 years old to about 12 years old, about 3 years old to about 12 years old.

Additional Information on a Subject In some embodiments, additional information is collected regarding a subject. The additional information can be, e.g., appearance, age, dress, general level of comfort of the subject, gender, grooming, name, occupation, height, weight, ethnicity, body fat percentage, body fat index, Body Mass Index (BMI), bowel movement schedule, hair color, eye color, hours of sleep per day, sleep quality index score, pain index score, pain scale score, pain threshold test result, hearing test result, optometry exam result, appetite level, hunger scale score, number of calories consumed per day, volume of liquid consumed per day, thirst scale score, urination frequency, urination amount, libido scale score, erection frequency, time spent in sedentary activity per day, activity level, activity type, activity schedule, energy level, exercise level, exercise test result, fatigue level, well-being, nausea frequency, PSA level, cholesterol level, blood pressure, systolic blood pressure, diastolic blood pressure, cardiac stress test result, blood glucose level, heart rate, spirometry test result, lung volume measurement, lung diffusion capacity, VO2 max, oximeter reading, biomarker level, presence or absence of a biomarker, biopsy result, disease severity, frequency of social contacts, duration of social contacts, place where a subject lives, type of building in which a subject lives, city in which a subject lives, or state in which a subject lives.

Additional information can include attention span, e.g., ability to complete a thought, ability to think and problem solve, whether a subject is easily distracted, etc.

Conditions

The subject can have, or be suspected of having, a condition. The condition can be, e.g., a neurological or neurocognitive condition. The neurological or neurocognitive condition can be a neurological disorder listed on the National Institute of Neurological Disorders and Stroke webpage (www.ninds.nih gov/disorders/disorder_index.htm). The subject can have a sign or symptom. The neurological or neurocognitive condition, or symptom, can be, e.g., abarognosis (e.g., loss of the ability to detect the weight of an object held in the hand or to discern the difference in weight between two objects), acid lipase disease, acid maltase deficiency, acquired epileptiform aphasia, absence of the septum pellucidum, acute disseminated encephalomyelitis, adie's pupil, Adie's syndrome, adrenoleukodystrophy, agenesis of the corpus callosum, agnosia, Aicardi syndrome, Aicardi-Goutieres syndrome disorder, AIDS—neurological complications, akathisia, alcohol related disorders, Alexander disease, Alien hand syndrome (anarchic hand), allochiria, Alpers' disease, altitude sickness, alternating hemiplegia, Alzheimer's disease, amyotrophic lateral sclerosis, anencephaly, aneurysm, Angelman syndrome, angiomatosis, anoxia, Antiphospholipid syndrome, aphasia, apraxia, arachnoid cysts, arachnoiditis, arnold-chiari malformation, Asperger syndrome, arteriovenous malformation, ataxia, ataxias and cerebellar or spinocerebellar degeneration, ataxia telangiectasia, atrial fibrillation, stroke, attention deficit hyperactivity disorder, auditory processing disorder, autism, autonomic dysfunction, back pain, Barth syndrome, Batten disease, becker's myotonia, Behcet's disease, bell's palsy, benign essential blepharospasm, benign focal amyotrophy, benign intracranial hypertension, Bernhardt-Roth syndrome, bilateral frontoparietal polymicrogyria, Binswanger's disease, blepharospasm, Bloch-Sulzberger syndrome, brachial plexus birth injuries, brachial plexus injury, Bradbury-Eggleston syndrome, brain or spinal tumor, brain abscess, brain aneurysm, brain damage, brain injury, brain tumor, Brown-Sequard syndrome, bulbospinal muscular atrophy, CADASIL (cerebral autosomal dominat arteriopathy subcortical infarcts and leukoencephalopathy), Canavan disease, Carpal tunnel syndrome, causalgia, cavernomas, cavernous angioma, cavernous malformation, Central cervical cord Syndrome, Central cord syndrome, Central pain syndrome, central pontine myelinolysis, centronuclear myopathy, cephalic disorder, ceramidase deficiency, cerebellar degeneration, cerebellar hypoplasia, cerebral aneurysm, cerebral arteriosclerosis, cerebral atrophy, cerebral beriberi, cerebral cavernous malformation, cerebral gigantism, cerebral hypoxia, cerebral palsy, cerebral vasculitis, Cerebro-Oculo-Facio-Skeletal syndrome (COFS), cervical spinal stenosis, Charcot-Marie-Tooth disease, chiari malformation, Cholesterol ester storage disease, chorea, choreoacanthocytosis, Chronic fatigue syndrome, chronic inflammatory demyelinating polyneuropathy (CIDP), chronic orthostatic intolerance, chronic pain, Cockayne syndrome type II, Coffin-Lowry syndrome, colpocephaly, coma, Complex regional pain syndrome, compression neuropathy, concussion, congenital facial diplegia, congenital myasthenia, congenital myopathy, congenital vascular cavernous malformations, corticobasal degeneration, cranial arteritis, craniosynostosis, cree encephalitis, Creutzfeldt-Jakob disease, cumulative trauma disorders, Cushing's syndrome, Cytomegalic inclusion body disease (CIBD), cytomegalovirus infection, Dancing eyes-dancing feet syndrome (opsoclonus myoclonus syndrome), Dandy-Walker syndrome (DWS), Dawson disease, decompression sickness, De morsier's syndrome, dejerine-klumpke palsy, Dejerine-Sottas disease, Delayed sleep phase syndrome, dementia, dementia—multi-infarct, dementia—semantic, dementia—subcortical, dementia with lewy bodies, dentate cerebellar ataxia, dentatorubral atrophy, depression, dermatomyositis, developmental dyspraxia, Devic's syndrome, diabetes, diabetic neuropathy, diffuse sclerosis, Dravet syndrome, dysautonomia, dyscalculia, dysgraphia, dyslexia, dysphagia, dyspraxia, dyssynergia cerebellaris myoclonica, dyssynergia cerebellaris progressiva, dystonia, dystonias, Early infantile epileptic, Empty sella syndrome, encephalitis, encephalitis lethargica, encephalocele, encephalopathy, encephalopathy (familial infantile), encephalotrigeminal angiomatosis, encopresis, epilepsy, epileptic hemiplegia, erb's palsy, erb-duchenne and dejerine-klumpke palsies, erythromelalgia, essential tremor, extrapontine myelinolysis, Fabry's disease, Fahr's syndrome, fainting, familial dysautonomia, familial hemangioma, familial idiopathic basal ganglia calcification, familial periodic paralyses, familial spastic paralysis, Farber's disease, febrile seizures, fibromuscular dysplasia, fibromyalgia, Fisher syndrome, floppy infant syndrome, foot drop, Foville's syndrome, friedreich's ataxia, frontotemporal dementia, Gaucher's disease, generalized gangliosidoses, Gerstmann's syndrome, Gerstmann-Straussler-Scheinker disease, giant axonal neuropathy, giant cell arteritis, Giant cell inclusion disease, globoid cell leukodystrophy, glossopharyngeal neuralgia, Glycogen storage Disease, gray matter heterotopia, Guillain-Barr-syndrome, Hallervorden-Spatz disease, head injury, headache, hemicrania continua, hemifacial spasm, hemiplegia alterans, hereditary neuropathies, hereditary spastic paraplegia, heredopathia atactica polyneuritiformis, herpes zoster, herpes zoster oticus, Hirayama syndrome, Holmes-Adie syndrome, holoprosencephaly, HTLV-1 associated myelopathy, HIV infection, Hughes syndrome, Huntington's disease, hydranencephaly, hydrocephalus, hydrocephalus—normal pressure, hydromyelia, hypercortisolism, hypersomnia, hypertension, hypertonia, hypotonia, hypoxia, immune-mediated encephalomyelitis, inclusion body myositis, incontinentia pigmenti, infantile hypotonia, infantile neuroaxonal dystrophy, Infantile phytanic acid storage disease, Infantile refsum disease, infantile spasms, inflammatory myopathy, inflammatory myopathies, iniencephaly, intestinal lipodystrophy, intracranial cyst, intracranial hypertension, Isaac's syndrome, Joubert syndrome, Karak syndrome, Kearns-Sayre syndrome, Kennedy disease, Kinsbourne syndrome, Kleine-Levin syndrome, Klippel feil syndrome, Klippel-Trenaunay syndrome (KTS), Kluver-Bucy syndrome, Korsakoffs amnesic syndrome, Krabbe disease, Kugelberg-Welander disease, kuru, Lafora disease, lambert-eaton myasthenic syndrome, Landau-Kleffner syndrome, lateral femoral cutaneous nerve entrapment, Lateral medullary (wallenberg) syndrome, learning disabilities, Leigh's disease, Lennox-Gastaut syndrome, Lesch-Nyhan syndrome, leukodystrophy, Levine-Critchley syndrome, lewy body dementia, Lipid storage diseases, lipoid proteinosis, lissencephaly, Locked-In syndrome, Lou Gehrig's, lumbar disc disease, lumbar spinal stenosis, lupus—neurological sequelae, lyme disease—neurological sequelae, Machado-Joseph disease (spinocerebellar ataxia type 3), macrencephaly, macropsia, megalencephaly, Melkersson-Rosenthal syndrome, Menieres disease, meningitis, meningitis and encephalitis, Menkes disease, meralgia paresthetica, metachromatic leukodystrophy, metabolic disorders, microcephaly, micropsia, migraine, Miller fisher syndrome, mini-stroke (transient ischemic attack), misophonia, mitochondrial myopathy, Mobius syndrome, Moebius syndrome, monomelic amyotrophy, mood disorder, Motor neurone disease, motor skills disorder, Moyamoya disease, mucolipidoses, mucopolysaccharidoses, multi-infarct dementia, multifocal motor neuropathy, multiple sclerosis, multiple system atrophy, multiple system atrophy with orthostatic hypotension, muscular dystrophy, myalgic encephalomyelitis, myasthenia—congenital, myasthenia gravis, myelinoclastic diffuse sclerosis, myoclonic encephalopathy of infants, myoclonus, myopathy, myopathy—congenital, myopathy—thyrotoxic, myotonia, myotonia congenita, myotubular myopathy, narcolepsy, neuroacanthocytosis, neurodegeneration with brain iron accumulation, neurofibromatosis, Neuroleptic malignant syndrome, neurological complications of AIDS, neurological complications of lyme disease, neurological consequences of cytomegalovirus infection, neurological manifestations of AIDS, neurological manifestations of pompe disease, neurological sequelae of lupus, neuromyelitis optica, neuromyotonia, neuronal ceroid lipofuscinosis, neuronal migration disorders, neuropathy—hereditary, neurosarcoidosis, neurosyphilis, neurotoxicity, neurotoxic insult, nevus cavernosus, Niemann-pick disease, Non 24-hour sleep-wake syndrome, nonverbal learning disorder, normal pressure hydrocephalus, O'Sullivan-McLeod syndrome, occipital neuralgia, occult spinal dysraphism sequence, Ohtahara syndrome, olivopontocerebellar atrophy, opsoclonus myoclonus, Opsoclonus myoclonus syndrome, optic neuritis, orthostatic hypotension, Overuse syndrome, chronic pain, palinopsia, panic disorder, pantothenate kinase-associated neurodegeneration, paramyotonia congenita, Paraneoplastic diseases, paresthesia, Parkinson's disease, paroxysmal attacks, paroxysmal choreoathetosis, paroxysmal hemicrania, Parry-Romberg syndrome, Pelizaeus-Merzbacher disease, Pena shokeir II syndrome, perineural cysts, periodic paralyses, peripheral neuropathy, periventricular leukomalacia, persistent vegetative state, pervasive developmental disorders, photic sneeze reflex, Phytanic acid storage disease, Pick's disease, pinched nerve, Piriformis syndrome, pituitary tumors, PMG, polio, polymicrogyria, polymyositis, Pompe disease, porencephaly, Post-polio syndrome, postherpetic neuralgia (PHN), postinfectious encephalomyelitis, postural hypotension, Postural orthostatic tachycardia syndrome, Postural tachycardia syndrome, Prader-Willi syndrome, primary dentatum atrophy, primary lateral sclerosis, primary progressive aphasia, Prion diseases, progressive hemifacial atrophy, progressive locomotor ataxia, progressive multifocal leukoencephalopathy, progressive sclerosing poliodystrophy, progressive supranuclear palsy, prosopagnosia, Pseudo-Torch syndrome, Pseudotoxoplasmosis syndrome, pseudotumor cerebri, Rabies, Ramsay hunt syndrome type I, Ramsay hunt syndrome type II, Ramsay hunt syndrome type III, Rasmussen's encephalitis, Reflex neurovascular dystrophy, Reflex sympathetic dystrophy syndrome, Refsum disease, Refsum disease—infantile, repetitive motion disorders, repetitive stress injury, Restless legs syndrome, retrovirus-associated myelopathy, Rett syndrome, Reye's syndrome, rheumatic encephalitis, rhythmic movement disorder, Riley-Day syndrome, Romberg syndrome, sacral nerve root cysts, saint vitus dance, Salivary gland disease, Sandhoff disease, Schilder's disease, schizencephaly, schizophrenia, Seitelberger disease, seizure disorder, semantic dementia, sensory integration dysfunction, septo-optic dysplasia, severe myoclonic epilepsy of infancy (SMEI), Shaken baby syndrome, shingles, Shy-Drager syndrome, Sjögren's syndrome, sleep apnea, sleeping sickness, snatiation, Sotos syndrome, spasticity, spina bifida, spinal cord infarction, spinal cord injury, spinal cord tumors, spinal muscular atrophy, spinocerebellar ataxia, spinocerebellar atrophy, spinocerebellar degeneration, Steele-Richardson-Olszewski syndrome, Stiff-Person syndrome, striatonigral degeneration, stroke, Sturge-Weber syndrome, subacute sclerosing panencephalitis, subcortical arteriosclerotic encephalopathy, SUNCT headache, superficial siderosis, swallowing disorders, sydenham's chorea, syncope, synesthesia, syphilitic spinal sclerosis, syringohydromyelia, syringomyelia, systemic lupus erythematosus, tabes dorsalis, tardive dyskinesia, tardive dysphrenia, tarlov cyst, Tarsal tunnel syndrome, Tay-Sachs disease, temporal arteritis, tetanus, Tethered spinal cord syndrome, Thomsen disease, thomsen's myotonia, Thoracic outlet syndrome, thyrotoxic myopathy, tic douloureux, todd's paralysis, Tourette syndrome, toxic encephalopathy, transient ischemic attack, transmissible spongiform encephalopathies, transverse myelitis, traumatic brain injury, tremor, trigeminal neuralgia, tropical spastic paraparesis, Troyer syndrome, trypanosomiasis, tuberous sclerosis, ubisiosis, uremia, vascular erectile tumor, vasculitis syndromes of the central and peripheral nervous systems, viliuisk encephalomyelitis (VE), Von economo's disease, Von Hippel-Lindau disease (VHL), Von recklinghausen's disease, Wallenberg's syndrome, Werdnig-Hoffman disease, Wernicke-Korsakoff syndrome, West syndrome, Whiplash, Whipple's disease, Williams syndrome, Wilson's disease, Wolman's disease, X-linked spinal and bulbar muscular atrophy, Zellweger syndrome

The condition can be an adverse effect of major surgery or other medical procedure, an effect of a therapeutic pharmacological intervention, drug dependence, or malingering of mental illness or neurological and neuropsychological disorders and impairments. The neurological disorder can be a neurological disorder described, e.g., in U.S. Patent Application Publication No. 20120021391.

The condition can be, e.g., a disease. In some embodiments, the condition is cancer, an autoimmune disease, or a bacterial or viral infection.

Tests

A subject can be administered a test or assessment. In some embodiments, the test can be a neurological examination. The neurological examination can be an examination described on the National Institute of Neurological Disorders and Stroke website (e.g., www.ninds.nih gov/disorders/misc/diagnostic_tests.htm#examination). The neurological examination can assess, e.g., motor and sensory skills, the functioning of one or more cranial nerves, hearing, speech, vision, coordination and balance, mental status, changes in mood or behavior, among other abilities.

Instruments that can be used in neurological examination can include, e.g., a tuning fork, flashlight, reflex hammer, ophthalmoscope, X-ray, fluoroscope, or a needle.

A procedure that can be performed to diagnose a neurological condition can include, e.g., angiography, biopsy, a brain scan (e.g., computed tomography (CT), magnetic resonance imaging (MRI), positron emission tomography (PET)), cerebrospinal fluid analysis (by, e.g., lumbar puncture or spinal tap), discography, intrathecal contrast-enhanced CT scan (cisternograhpy), electronencephalography (EEG), electromyography (EMG), nerve conduction velocity (NCV) test, electronystagmography (ENG), evoked potentials (evoked response; e.g., auditory evoked potentials, visual evoked potentials, somatosensory evoked potentials), myelography, polysomnogram, single photon emission computed tomography (SPECT), thermography, or ultrasound imaging (e.g., neurosonography, transcranial Doppler ultrasound). One or more procedures that can diagnose a neurological condition can be performed on a subject.

A sample can be taken from a subject for use in a test. The sample can be a bodily fluid. The bodily fluid can be, e.g., aqueous humor, vitreous humor, bile, blood, plasma, serum, breast milk, cerebrospinal fluid, cerumen (earwax), endolymph, perilymph, female ejaculate, gastric juice, mucus (e.g., nasal drainage, phlegm), peritoneal fluid, pleural fluid, saliva, sebum (e.g., skin oil), semen, sweat, tears, vaginal secretion, vomit, or urine. The sample can be a cell or tissue, e.g., liver, lung, colon, pancreas, bladder, brain, breast, cervix, esophagus, eye, gallbladder, kidney, stomach, ovary, penis, prostate, pituitary, salivary gland, skin, testicle, uterus, and vagina. A sample from the brain can be form the corpus collosum, basal ganglia, cerebral cortex (frontal lobe, parietal lobe, occipital lobe, temporal lobe), cerebellum, thalamus, hypothalamus, amygdale, or hippocampus. The sample can be used in a laboratory screening test.

In some embodiments, a subject is administered a genetic test. The performance of the genetic test can comprise hybridizing nucleic acid from a sample from a subject to a microarray. The performance of the genetic test can comprise sequencing nucleic acid from a subject. In some embodiments, the sequencing comprises massively parallel sequencing. The sequencing can be 454 sequencing (Roche), Illumina (Solexa) sequencing, SOLiD sequencing (ABI), ion semiconductor sequencing (Ion Torrent Systems), DNA nanoball sequencing (Complete Genomics), HELISCOPE™ single molecule sequencing (Helicos), single molecule SMRT™ sequencing (Pacific Biosciences), single molecule real time (RNAP) sequencing, nanopore DNA sequencing, or sequencing using technology from VisiGen Biotechnologies.

A subject that is a woman that is pregnant or suspected of being pregnant can be administered a genetic test to identify genetic abnormalities in a fetus. The genetic test can include, e.g., amniocentesis, chorionic villus sampling (CVS), uterine ultrasound, a VERIFI™ prenatal test (VERINATA HEALTHT™), MATERNIT21 PLUS™ test (SEQUENOM®), OR HARMONY PRENATAL TEST™ (ARIA™ Health), (NATERA™). The genetic test can comprise massively parallel sequencing, or next generation sequencing, of a sample from a pregnant woman or a woman suspected of being pregnant.

A subject can be administered one or more tests. A subject can be administered about, or more than about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 tests. The subject can be administered about 1 to about 10, about 5 to about 10, about 10 to about 20, about 20 to about 30, about 30 to about 40, about 40 to about 50, about 50 to about 60, about 60 to about 70, about 70 to about 80, about 80 to about 90, about 90 to about 100, about 1 to about 20, about 1 to about 30, about 1 to about 40, about 1 to about 50, about 1 to about 60, about 1 to about 70, about 1 to about 80, about 1 to about 90, or about 1 to about 100 tests. Two or more tests can form a battery.

A test can be a psychological assessment. The psychological assessment can be, e.g., a psychological assessment described at www.valueoptions.com/providers/Forms/Clinical/Listof Psychological_Tests.pdf. In some embodiments, a psychological assessment is a neurocognitive (neuro) assessment. A neurocognitive assessment can be an evaluation conducted to determine a subject's level of thinking skills, including, e.g., memory, attention, reasoning, visual-perceptual skills, or the ability to manage everyday activities. In some embodiments, a standardized neurocognitive assessment is conducted within the framework of a clinical drug trial to understand the potential impact of a new treatment on cognitive functioning. In some embodiments, a trained and certified professional administers a neurocognitive assessment to a subject. The neurocognitive assessment can comprise a battery of reliable and validated paper and pencil and/or computerized tests.

In some embodiments, the psychological assessment is an academic achievement instrument, e.g., Diagnostic Achievement Battery-2 (DAB2).

In some embodiments, the psychological assessment is an academic skills instrument, e.g., Wechsler Individual Achievement Test (WIAT), Wechsler Individual Achievement Test for Children (WIAT), Woodcock-Johnson Psychoeduca Battery (Achievement), or Woodcock Reading Mastery Tests-R.

In some embodiments, the psychological assessment is an antisocial personality instrument, e.g., Jesness Inventory or Jesness Inventory Revised (JI-R).

In some embodiments, the psychological assessment is an attention instrument, e.g., D2 Test of Attention, Gordon Diagnostic System, Integrated Visual and Auditory Continuous Performance Test (IVACPT), Quotient Test of Attention, Test of Everyday Attention (TEA) (TEA-CH for children), or Test of Variables of Attention (TOVA).

In some embodiments, the psychological assessment is an attention measure instrument, e.g., Brief Test of Attention (BTA).

In some embodiments, the psychological assessment is an attention/ADHD instrument, e.g., QB Test or Auditory Continuous Performance Test.

In some embodiments, the psychological assessment is an autism diagnosis instrument, e.g., Autism Diagnostic Interview (ADI-R).

In some embodiments, the psychological assessment is a back pain assessment instrument, e.g., Fear-Avoidance Beliefs Questionnaire (FABQ).

In some embodiments, the psychological assessment is a behavior rating scale instrument, e.g., Children's State-Trait Anxiety Inventory, Early Childhood Attention Deficit Disorders Evaluation Scale (ECADDES), Home Situations Questionnaire (HSQ, HSQ-R), Louisville Behavioral Checklist, NICHQ Vanderbilt Assessment Scale, Pediatric Attention Disorders Diagnostic Screener (PADDS), Revised Behavior Problem Checklist (RBPC), School Behavior Checklist, School Motivation and Learning Strategies Inventory (SMLSI), Social Phobia and Anxiety Inventory, Social Responsiveness Scale (SRS), Structured Clinical Interview (SCID II Patient Questionnaire), State-Trait Anger Expression Inventory, State-Trait Anxiety Inventory, Wender Utah Rating Scale, Achenbach System of Empirically Based Assessment, Preschool Module, Caregiver-Teacher Report Form, Child Behavior Checklist (CBCL), Teacher Report Form, Youth Self-Report (YSR), ACTeERS-ADD-H Comprehensive, Teachers Rating Scale, Adaptive Behavior Assessment System (ABAS II), ADHD Rating Scale, Adolescent Anger Rating Scale, Adult Behavior Checklist (ABCL), Amen System Checklist, Attention Deficit Disorder Eval. Scales (ADDES), Attention-Deficit/Hyperactivity Disorder Test (ADHDT), Attention-Deficit Scales for Adults (ADSA), Behavior Assessment System for Children (BASC), Brief Symptom Inventory, Brown Attention-Deficit Disorder Scales, Burk's Behavior Rating Scale, Child Bipolar Questionnaire (CBQ), Children's Attention & Adjustment Survey (CAAS), Comprehensive Behavior Rating Scale for Children (CBRSC), Conner's Adult ADHD Rating Scale (CAARS), Conner's Rating Scale-Teacher or Parent, Conner's Rating Scales-Revised, Feelings, Attitudes and Behaviors Scale for Children, or School Situations Questionnaire (SSQ, SSQ-R)/Survey.

In some embodiments, the psychological assessment is a chemical dependency instrument, e.g., Maryland Addictions Questionnaire (MAQ), Personal Experience Inventory for Adolescents (PEI), Personal Experience Inventory for Adults (PEI-A), Substance Abuse Subtle Screening Inventory (SASSI), or Western Personality Inventory.

In some embodiments, the psychological assessment is a cognitive/IQ instrument, e.g., Woodcock-Johnson Psychoeducational Battery.

In some embodiments, the psychological assessment is a development instrument, e.g., Bayley Scales of Infant Development.

In some embodiments, the psychological assessment is a development/personality instrument, e.g., Child Development Inventory-4.

In some embodiments, the psychological assessment is a development or neuro instrument, e.g., Developmental Test of Visual Perception (DTVP)-2.

In some embodiments, the psychological assessment is a developmental instrument, e.g., Adaptive Behavior Scale (ABS), Kaufman Functional Academic Skills Test (K-FAST), Peabody Developmental Motor Scales and Activity Cards, Scales of Independent Behavior (Woodcock Johnson) (SIB)-R, or Vineland Adaptive Behavior Scales (VABS).

In some embodiments, the psychological assessment is a developmental assessment instrument, e.g., Battell Developmental Inventory.

In some embodiments, the psychological assessment is an educational instrument, e.g., Burt Word Reading, Dyslexia Screening Instrument, Gray Oral Reading Test (GORT-R or GORT-3), Kaufman Test of Education Achievement (K-TEA), Key-Math Diagnostic Arithmetic Test—Revised, Learning Disabilities Diagnostic Inventory (LDDI), Peabody Individual Achievement Test—Revised (PIAT-R), Process Assessment of the Learner (PAL)-II, Test of Auditory Analysis Skills (TAAS), Test of Auditory-Perceptual Skills (TAPS)-R, Test of Early Math Ability (TEMA), Test of Early Reading Ability (TERA)-3, Test of Language Competence-Expanded (TLC-E), Test of Pragmatic Language (TOPL), Test of Word Reading Efficiency (TOWRE), Test of Written Language (TOWL)-4, or Wechsler Test of Adult Reading (WTAR).

In some embodiments, the psychological assessment is an educational or neuro instrument, e.g., Developmental Indicators for the Assessment of Learning (DIAL)-3, Differential Ability Sale (DAS), Gray Silent Reading Test, Nelson-Denny Reading Test (Forms G and H), Oral and Written Language Skills (OWLS), Preschool Language Scale, 4th Edition (PLS-4), SCAN-3C: Test for Auditory Processing Disorders in Children, Scholastic Abilities Test for Adults (SATA), Standardized Reading Inventory-2nd Edition (SRI-2), Test of Auditory Comprehension of Language-3, or Test of Problem Solving (TOPS).

In some embodiments, the psychological assessment is an emotional developmental instrument, e.g., Vineland Social-Emotional Early Childhood Scales.

In some embodiments, the psychological assessment is an intelligence instrument, e.g., Detroit Test of Learning Aptitude (DTLA)-4, General Ability Measure for Adults (GAMA), Kaufman Brief Intelligence Test (K-BIT), Kaufman Adolescent and Adult Intelligence Test, Leiter International Performance Scale Revised (Leiter-R), McCarthy Scales of Children's Abilities, Reynolds Intellectual Assessment Scales (RIAS), Reynolds Intellectual Screening Test (RIST), Shipley Institute of Living Scale, Slosson Full-Range Intelligence Test (S-FRIT), Slosson Intelligence Test—Revised, Stanford Binet Intelligence Scale, or Test of Nonverbal Intelligence-3 (TONI-3).

In some embodiments, the psychological assessment is an intelligence & academic skills instrument, e.g., Kaufman Assessment Battery for Children (KABC).

In some embodiments, the psychological assessment is an intelligence or educational instrument, e.g., Peabody Picture Vocabulary Test—Revised (PPVT-R).

In some embodiments, the psychological assessment is an intelligence or neuro instrument, e.g., Porteus Mazes.

In some embodiments, the psychological assessment is an IQ instrument, e.g., Wechsler Abbreviated Scale of Intelligence (WASI).

In some embodiments, the psychological assessment is an IQ/Neuro instrument, e.g., Wechsler Adult Intelligence Scale—Revised as a Neurological Instrument (WAIS-R NI).

In some embodiments, the psychological assessment is an IQ/Neuro or Problem Solving instrument, e.g., Raven's Progressive Matrices (all versions).

In some embodiments, the psychological assessment is an IQ-Multitask instrument, e.g., Wechsler Adult Intelligence Scale—III (WAIS-III), Wechsler Adult Intelligence Scale—IV (WAIS-IV), Wechsler Intell Scale for Children (WISC-IV), or Wechsler Preschool & Primary Scale of Intell. Rev (WPPSI-R).

In some embodiments, the psychological assessment is a language instrument, e.g., Woodcock Language Proficiency Battery-R.

In some embodiments, the psychological assessment is a malingering instrument, e.g., Validity Indicator Profile (VIP).

In some embodiments, the psychological assessment is a malingering/effort instrument, e.g., Test of Memory Malingering (TOMM).

In some embodiments, the psychological assessment is a marital/relationship instrument, e.g., Marital Satisfaction Inventory-Revised (MSI-R).

In some embodiments, the psychological assessment is a medical coping style instrument, e.g., Millon Behavioral Health Inventory (MBH/MBHI).

In some embodiments, the psychological assessment is a memory-LD instrument, e.g., Wepman's Auditory Memory Battery.

In some embodiments, the psychological assessment is a neuro instrument, e.g., Alzheimer's Quick Test (AQT), Animal Naming, Aphasia Screening Test (Reitan Indiana), Behavior Rating Inventory of Executive Functioning (BRIEF), Bender Visual Motor Gestalt Test, Benton Facial Recognition Test, Benton Judgment of Line Orientation Test, Benton Multilingual Aphasia Exam (BMAE), Benton MAE Sentence Repetition, Benton MAE Token Test, Benton MAE: Visual Naming Test, Benton Right-Left Orientation Test, Benton Serial Digit Learning Test, Benton Visual Form Discrimination Test, Benton Visual Retention Test, Booklet Categories Test, Boston Diagnostic Aphasia Examination-3, Boston Naming Test, Brief Neuropsychological Cognitive Exam, Brief Visuospatial Memory Test-Revised (BVMT-R), Buschke Selective Reminding Test, Category Test, Children's Category Test (CCT), Clinical Evaluation of Language Fundamentals (CELF)-4, Children's Memory Scale (CMS), Clock Drawing, Cognistat, Color Trails Test, Comprehensive Trail Making Test (CTMT), Computer Category Test, Conner's Continuous Performance Test II (CCPT), Digit Vigilance Test, Examining for Aphasia, Executive Control Battery (ECB), Expressive One Work Vocabulary Test—Revised, Expressive Oral-Word Picture Vocabulary Test (EOPVT), Finger Tapping Test (Electric or Manual), Folstein Mini Mental Status, Frontal Systems Behavior Scale, Green Word Memory Test, Grip Strength, Grooved Pegboard, Hopkins Verbal Learning Test-R, Judgment of Line Orientation, Lateral Dominance Exam, Luria-Nebraska Neuropsych Battery, Luria-Nebraska Neuropsych—Screen Version, Luria-Nebraska Neuropsych Battery for Children, Luria-Nebraska Neuropsych for Children—Screen Version, Memory Assessment Scales, MicroCog Assessment of Cognitive Functioning, Minnesota Test for Differential Diagnosis of Aphasia, Multilingual Aphasia Examination (MAE)-3, NEPSY (Developmental Neuropsychological Assessment), Neuropsychological Assessment Battery (NAB), Philadelphia Head Injury Questionnaire, Progressive Figures Test, Purdue Pegboard, Quick Neurological Screening Test-2 (QNST-2), Receptive One Word Picture Vocabulary Test (ROWPVT), Repeatable Battery for Assessment of Neuropsychological Status (RBANS), Rey Auditory Verbal Learning Test, Rey-Osterrieth Complex figure Test (RCFT), Rivermead Behavioral Memory Test, Rivermead Perceptual Assessment Battery-III, Ruff 2 & 7 Selective Attention Test, Severe Impairment Battery (SIB), Speech Sounds Perception Test, Tactual Performance Task (TPT), Target Test, Wisconsin Card Sorting Test (WCST), or Tower of London.

In some embodiments, the psychological assessment is a neuro/behavior rating scale instrument, e.g., Neuropsych Questionnaire (NPQ) or Neuropsych Questionnaire Short Form (NPQ-SF).

In some embodiments, the psychological assessment is a neuro or educational instrument, e.g., Revised Token Test.

In some embodiments, the psychological assessment is a neuro battery instrument, e.g., Halstead Reitan Neuro Battery.

In some embodiments, the psychological assessment is a neuro screen instrument, e.g., Kaufman Short Neuropsychological Assess Procedure (K-SNAP) or Neuropsychological Impairment Scale.

A Neuro, educational instrument can be, e.g., Auditory Consonant Trigram Test (ACT).

A Neuro, Forensic instrument can be, e.g., Conner's Continuous Performance Test, Kiddie Version (KCPT).

In some embodiments, the psychological assessment is a neuro, malingering instrument, e.g., Rey 15-Item Test.

In some embodiments, the psychological assessment is a neuro/educational instrument, e.g., BRIEF (Behavior Rating Inventory of Executive Functioning), Cognitive Abilities Scale II (CAS), Cognitive Assessment System (CAS), Comprehensive Test of Phonological Processing (CTOPP), Wide Range Achievement Test—3rd Edition (WRAT-3), Wide Range Achievement Test—4th Edition (WRAT-4), Wide Range Assessment of Memory & Learning (WRAML), or Wide Range Assessment of Visual Motor Abilities (WRAVMA).

In some embodiments, the psychological assessment is a neuro/language/educational instrument, e.g., Test of Language Development—Primary (TOLD P:3) or Test of Language Development—Intermediary (TOLD P:3).

In some embodiments, the psychological assessment is a neuro/LD: language instrument, e.g., Wepman Auditory Discrimination Test.

In some embodiments, the psychological assessment is a neuro/LD: visual instrument, e.g., Beery VMI (Test of Visual-Motor Integration).

In some embodiments, the psychological assessment is a neuro/LD; memory instrument, e.g., Visual-Aural Digit Span Test.

In some embodiments, the psychological assessment is a neuro: attention instrument, e.g., Paced Auditory Serial Addition Task (PASAT: C) or Stoop Color Naming, Symbol-Digit Modalities test.

In some embodiments, the psychological assessment is a neuro: educational instrument, e.g., Test of Visual-Motor Skills, Upper Level, Test of Visual-Motor Skills, Revised, Test of Visual-Perceptual Skills Revised (non-motor) (TVPS-3), or Test of Visual-Perceptual Skills Revised (non-motor) Upper Level (TVPS-3).

In some embodiments, the psychological assessment is a neuro: exec instrument, e.g., Delis-Kaplan Executive Functional Scale (D-KEFS).

In some embodiments, the psychological assessment is a neuro: language instrument, e.g., Western Aphasia Battery.

In some embodiments, the psychological assessment is a neuro: memory instrument, e.g., Fuld Object Memory Evaluation or Wechsler Memory Scale—3rd Ed. (WMS-III).

In some embodiments, the psychological assessment is a neuro: memory/learning instrument, e.g., California Verbal Learning Test (CVLT) or California Verbal Learning Test for Children (CVLT).

In some embodiments, the psychological assessment is a neuro: perceptual instrument, e.g., Seashore Rhythm Test.

In some embodiments, the psychological assessment is a neuro: problem solving instrument, e.g., Short Category Test, Booklet Format.

In some embodiments, the psychological assessment is a neuro: screen instrument, e.g., Dementia Rating Scales (Mattis).

In some embodiments, the psychological assessment is a neuro: visual instrument, e.g., Visual-Motor Integration (VMI).

In some embodiments, the psychological assessment is a neuro or attention instrument, e.g., Trail Making Test.

In some embodiments, the psychological assessment is a neuro or developmental instrument, e.g., Sensory Profile, Short Sensory Profile, Survey of Teenage Readiness and Neurodevelopment Status (STRANDS) or Test of Visual-Motor Integration (see Beery VMI).

In some embodiments, the psychological assessment is a neuro or educational instrument can be, e.g., Comprehensive Assessment of Spoken Language (CASL), Contextual Memory Test (CMT), Controlled Oral Word Association Test (COWAT or COWA), Developmental Profile II, Diagnostic Assessment of Reading (DAR), Jordon Left-Right Reversal Test-R, Motor-Free Visual Perception Test, Mullen Scales of Early Learning, or Working Memory Test Battery for Children.

In some embodiments, the psychological assessment is a neuro or forensic instrument, e.g., Computerized Assessment of Response Bias (CARB), Dot Counting Test (DCT), or Independent Living Scales (ILS).

In some embodiments, the psychological assessment is a neuro-language instrument, e.g., Token Test (Revised Token Test or Token Test for children).

In some embodiments, the psychological assessment is a neuro-mem-LD instrument, e.g., Test of Memory and Learning (TOMAL).

In some embodiments, the psychological assessment is a neuro-memory/learning instrument, e.g., Children's Auditory Verbal Learning Test-2 (CAVLT).

A Neurosych instrument can be, e.g., Hooper Visual Organization Test (VOT).

In some embodiments, the psychological assessment is a nonverbal test of intelligence instrument e.g., Comprehensive Test of Nonverbal Intelligence (CTONI).

In some embodiments, the psychological assessment is an objective personality instrument, e.g., Depression and Anxiety in Youth Scale (DAYS) or California Psychological Inventory (CPI).

In some embodiments, the psychological assessment is a pain adaptation instrument, e.g., Chronic Pain Battery.

In some embodiments, the psychological assessment is a pain assessment instrument, e.g., Screener and Opioid Assessment for Patients with Pain—Revised (SOAPP-R).

In some embodiments, the psychological assessment is a pain disorders instrument, e.g., Pain Apperception Test, or Pain Patient Profile (P3).

In some embodiments, the psychological assessment is a parental style instrument, e.g., Parenting Stress Index (PSI).

In some embodiments, the psychological assessment is a personality inventory instrument, e.g., Children's Personality Questionnaire (CPQ), Millon Adolescent Personality Inventory (MAPI), Millon Pre-Adolescent Clinical Inventory (M-PACI), Multidimensional Anxiety Scale for Children (MASC), Multidimensional Health Profile, Omni Personality Inventory, Omni IV Personality Disorder Inventory, Personality Inventory for Youth (PIY), or Sixteen Personality Factor Questionnaire (16 PF).

In some embodiments, the psychological assessment is a personality rating scale instrument, e.g., Beck Scale for Suicidal Ideation, Endler Multidimensional Anxiety Scales, Hamilton Rating Scale for Depression-Revised (Self-Report), or Problem Behavior Inventory.

In some embodiments, the psychological assessment is a personality instrument, e.g., 16 Personality Factor Questionnaire (16-PF), Adolescent Psychopathology Scale, Children's Depression Inventory (CDI), Children's Depression Rating Scale, Revised, Children's Manifest Anxiety Scale Revised, Children's Personality Questionnaire, Coping Responses Inventory (CRI), Detailed Assessment of Posttraumatic Stress (DAPS), Devereau Scales of Mental Disorders, Dyadic Adjustment Scale, Eating Inventory, Eating Disorder Inventory 2 (EDI-2), Fundamental Interpersonal Relations Orientation-Behavior (FIRO-B), Guilford-Zimmerman Temperament Survey, Hamilton Rating Scale for Depression-Revised (Clinician Form), Hare Psychopathy check list-R (PCL-R), High School Personality Inventory, Impact of Weight on Quality of Life Questionnaire (IWQOL), Millon Adolescent Personality Inventory (MAPI), Millon Behavioral Medicine Diagnostic (MBMD), Millon Clinical Multiaxial Inventory-III (MCMI), Millon Adolescent Clinical Inventory (MACI), Minnesota Multiphasic Pers. Inventory-2 (MMPI-2), Minnesota Multiphasic Pers. Inventory-Adolesc. (MMPI-A), Mooney Problem Check Lists, Multiscore Depression Inventory for Children, Multiscore Depression Inventory for Adolescents and Adults, NEO Personality-R (NEO PI-R), Paulhaus Deception Scales, Personality Assessment Inventory (PAI), Personality Inventory for Children-R, Personality Research Form (PRF), Piers-Harris Children's Self Anapt Scale, Posttraumatic Stress Diagnostic Scale (PDS), Problem Experiences Checklist, Projective Drawings, Psychological Screening Inventory, Quality of Life Inventory (QOLI), Resiliency Scales for Children and Adolescents, Revised Children's Manifest Anxiety Scale (RCMAS)-2, Reynolds Adolescent Depression Scale-2, Reynolds Adolescent Adjustment Screening Inventory, Reynolds Child Depression Scale, Rosenzweig Picture Frustration Study, Suicide Probability Scale, Trauma Symptom Checklist for Children (TSC), Trauma Symptom Inventory (TSI), Yale-Brown Obsessive Compulsive Scale, or Yale Food Addiction Scale.

In some embodiments, the psychological assessment is a personality scale instrument, e.g., Childhood Trauma Questionnaire.

In some embodiments, the psychological assessment is a personality test instrument, e.g., Basic Personality Inventory (BPI), Battery for Health Improvement (BHI), Beck Anxiety Inventory, Beck Depression Inventory, Beck Depression Inventory-II (BDI-II), or Beck Hopelessness Scale (BHS).

In some embodiments, the psychological assessment is a personality, pain coping instrument, e.g., McGill Pain Inventory.

In some embodiments, the psychological assessment is a personality/marital instrument, e.g., Taylor-Johnson Temperament Analysis.

In some embodiments, the psychological assessment is a prenatal style instrument, e.g., Parent-Child relationship Inventory (PCRI).

In some embodiments, the psychological assessment is a projective instrument, e.g., Incomplete Sentences Blank.

In some embodiments, the psychological assessment is a projective personality instrument, e.g., Adolescent Apperception Cards, Draw-a-Person (DAP), Hand Test, Holtzman Inkblot Test/Technique, House Tree Person (H-T-P), Human Figure Drawings, Kinetic Family Drawings (KFD), Make a Picture Story, Roberts Apperception Test for Children (RATC), Rorschach, Rotter Incomplete Sentence Test, Tasks of Emotional Development (TED), Tell-Me-A-Story (TEMAS), Test of Emotional Development (TED), Thematic Apperception Test (TAT), Children's Apperception Test (CAT), Children's Self Report Projective Inventory, Family Apperception Test, or Family Kinetic Drawing.

In some embodiments, the psychological assessment is a rating scale instrument, e.g., Asperger's Syndrome Diagnostic Scales (ASDS), Australian Scale for Asperger's Syndrome, Autism Diagnostic Observation Scale (ADOS), Carroll Depression Scale, Children's Atypical Development Scale, Child Symptom Inventory (CSI), Cognitive Coping Strategies Inventory-R, Gilliam Autism Rating Scale (GARS-2), Gilliam Asperger's Disorder Scale (GADS), Social Communication Questionnaire (SCQ), Zung Depression Index, or Childhood Autism Rating Scales (CARS)-2.

In some embodiments, the psychological assessment is a sex offender assessment instrument, e.g., Estimate of Risk of Adolescent Sexual Offense Recidivism (ERASOR), J-Soap Juvenile Sex Offender Assessment Protocol, Multiphasic Sex Inventory, PHASE, Risk-Sophistication-Treatment Inventory (RSTI), Sexual Adjustment Inventory-Juvenile, Sexual Attitude Questionnaire, or Symptom Assessment 45 (SA-45).

In some embodiments, the psychological assessment is a sexual interest instrument, e.g., ABEL Screen, e.g., DIANA SCREEN®, Abel Assessment for sexual interest—3™ (AASI-3), Abel Assessment for sexual interest-2™ (AASI-2), Abel-Blasingame Assessment System for individuals with intellectual Disabilities™ (ABID).

In some embodiments, the psychological assessment is a symptom checklist instrument, e.g., Symptom Checklist 90 Revised (SCL-90-R).

In some embodiments, the psychological assessment is a symptom rating scale instrument, e.g., Beck Youth Inventory, Hamilton Depression Inventory (HDI), Hamilton Depression Scale (HDS, HAMD, or HAD), Suicidal Ideation Questionnaire (SIQ), or SIQ-JR.

In some embodiments, the psychological assessment is a symptom screen instrument, e.g., Whitaker Index of Schizophrenic Thinking (WIST).

In some embodiments, the psychological assessment is Brief Assessment of Cognition in Schizophrenia (BACS), Brief Assessment of Cognition in Affective Disorders (BAC-A), Schizophrenia Cognition Rating Scale (SCoRS), Virtual Reality Functional Capacity Assessment Tool (VRFCAT)

In some embodiments, the psychological assessment is a test described in www.bcbsri.com/BCBSRIWeb/pdfinedical_policies/PsychologicalandNeuropsychologicalTesting.pdf.

In some embodiment, a test is administered as part of Clinical Antipsychotic Trials of Intervention Effectiveness (CATIE) trial.

In some embodiments, a test or assessment is administered by a trained and certified rater. In some embodiments, a trained and certified rater views a training video, reviews test-specific materials, and/or administers a test at least once to a colleague. A trained and certified rater can have administered a full testing battery to, e.g., a trainer during a, e.g., 2 hour session. In some embodiments, a test or assessment is administered by an individual with a MA, MD, or Ph.D.

Healthcare Provider

In some embodiments, a test or assessment can be administered to a subject by one or more healthcare providers. A healthcare provider can be, e.g., a clinical officer, clinical psychologist, a psychiatrist, a psychologist, marriage or family therapist, social worker, clinical social worker, occupational therapist, mental health nurse practitioner, audiologist, speech pathologist, a nurse, a physician (e.g., general practitioner or specialist) a physician assistant, a surgeon, obstetrician, obstetrical nurse, midwife, nurse practitioner, geriatrician, geriatric nurse, geriatric aide, surgical practitioner, anesthesiologist, nurse anesthetist, surgical nurse, operating department practitioner, anesthetic technician, surgical technologist, physiotherapist, orthotist, prosthetist, recreational therapist, dental hygienist, dentist, podiatrist, pedorthist, chiropractor, a medical technician, a pharmacist, dietitian, therapist, phlebotomist, physical therapist, respiratory therapist, optometrist, emergency medical technician, paramedic, medical laboratory technician, radiography, medical prosthetic technician, epidemiologist, or health inspector. A healthcare provider can record and collect data for a first clinical trial. In some embodiments, a healthcare provider will have undertaken special training or will have special qualifications to administer a test or assessment.

Data can be reviewed or analyzed by a healthcare provider. In some embodiments, data are reviewed or analyzed by a statistician.

Electronic Devices

Algorithms described herein can be executed on one or more electronic devices. An electronic device can be, e.g., a computer, e.g., desktop computer, laptop computer, notebook computer, minicomputer, mainframe, multiprocessor system, network computer, e-reader, netbook computer, or tablet. The electronic device can be a smartphone.

The computer can comprise an operating system. The operating system (OS) can be, e.g., Android, iOS, Linux, Mac OS X, Microsoft Windows, or Microsoft Windows XP. The operating system can be a real-time, multi-user, single-user, multi-tasking, single tasking, distributed, or embedded.

The systems and methods described herein can be implemented in or upon computer systems. Computer systems can include various combinations of a central processor or other processing device, an internal communication bus, various types of memory or storage media (RAM, ROM, EEPROM, cache memory, disk drives, etc.) for code and data storage, and one or more network interface cards or ports for communication purposes. The devices, systems, and methods described herein may include or be implemented in software code, which may run on such computer systems or other systems. For example, the software code can be executable by a computer system, for example, that functions as the storage server or proxy server, and/or that functions as a user's terminal device. During operation the code can be stored within the computer system. At other times, the code can be stored at other locations and/or transmitted for loading into the appropriate computer system. Execution of the code by a processor of the computer system can enable the computer system to implement the methods and systems described herein.

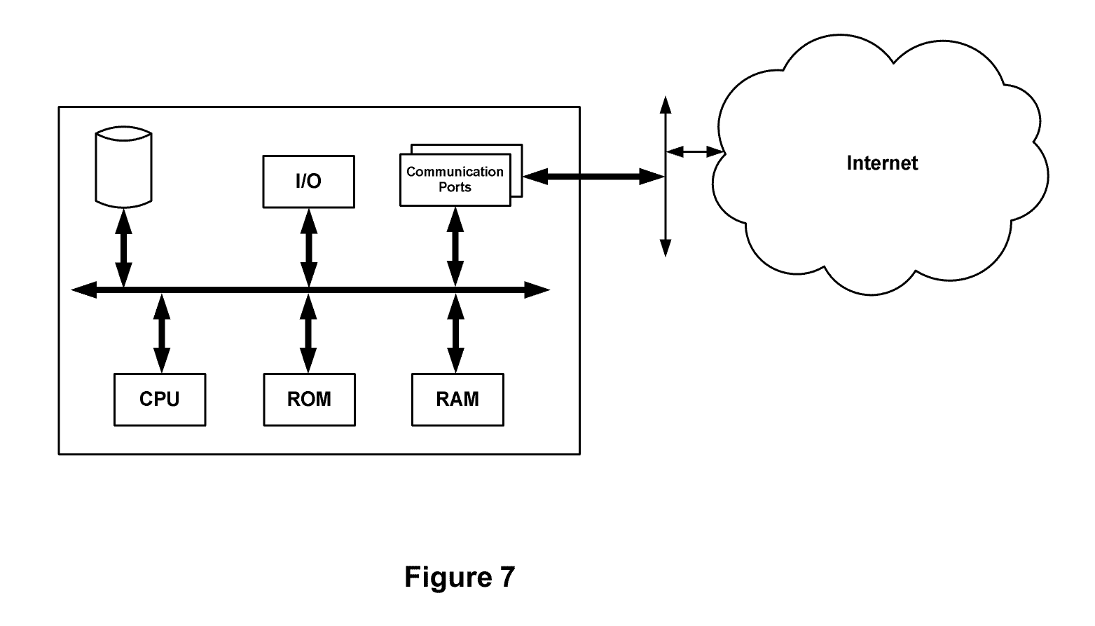

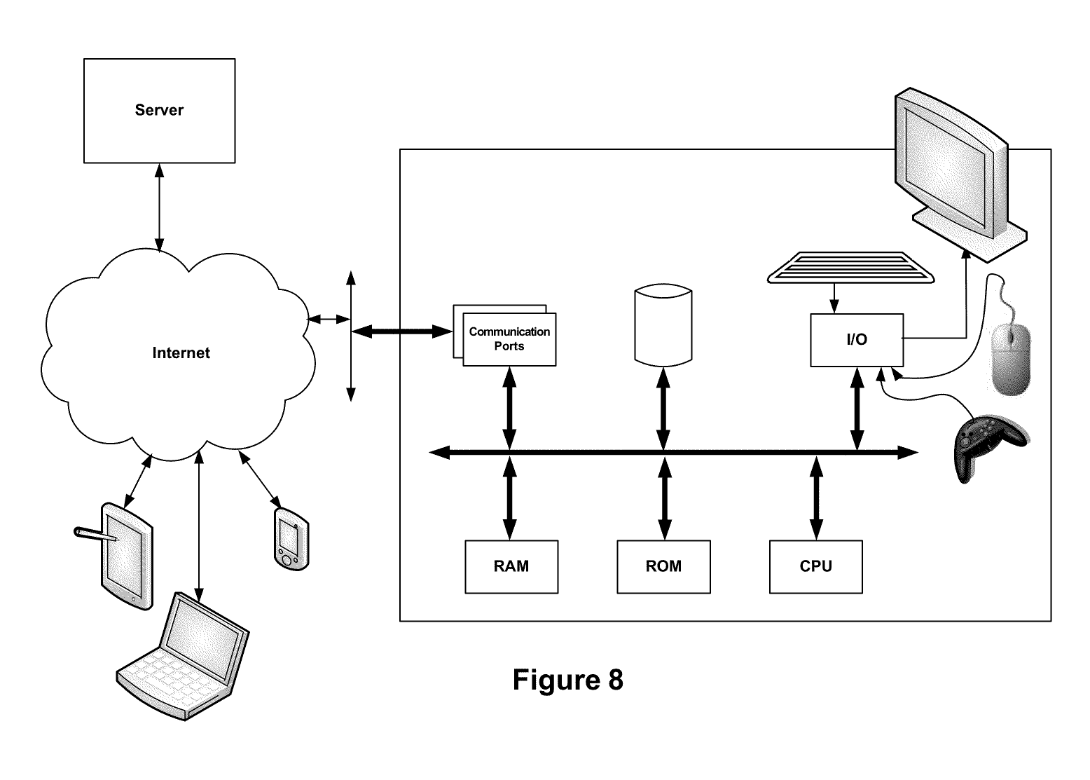

FIGS. 7 and 8 provide examples of functional block diagram illustrations of computer hardware platforms. FIG. 7 shows an example of a network or host computer platform, as can be used to implement a server or electronic devices, according to an embodiment. FIG. 8 depicts a computer or electronic device with user interface elements, as can be used to implement a personal computer, electronic device, or other type of work station or terminal device according to an embodiment, although the computer or electronic device of FIG. 8 can also act as a server if appropriately programmed. The systems and methods described herein can be implemented in or upon such computer hardware platforms in whole, in part, or in combination. The systems and methods described herein, however, are not limited to use in such systems and can be implemented or used in connection with other systems, hardware or architectures. The methods described herein can be implemented in computer software that can be stored in the computer systems, electronic devices, and servers described herein.

A computer system, electronic device or server, according to various embodiments, can include a data communication interface for packet data communication. The computer system, electronic device, or server can also include a central processing unit (CPU), in the form of one or more processors, for executing program instructions. The computer system, electronic device, or server can include an internal communication bus, program storage and data storage for various data files to be processed and/or communicated by the server, although the computer system or server can receive programming and data via network communications. The computer system, electronic device, or server can include various hardware elements, operating systems and programming languages. The electronic device, server or computing functions can be implemented in various distributed fashions, such as on a number of similar or other platforms.

The methods described herein can be implemented in mobile devices such as mobile phones, mobile tablets, smartphones, and other mobile devices with various communication capabilities including wireless communications, which may include radio frequency transmission, infrared transmission, or other communication technology. The hardware described herein can include transmitters and receivers for radio and/or other communication technology and/or interfaces to couple to and communicate with communication networks.

The methods described herein can be implemented in computer software that can be stored in the computer systems or electronic devices including a plurality of computer systems and servers. These can be coupled over computer networks including the internet. Accordingly, some embodiments include a network including the various system and devices coupled with the network.

Further, various methods and architectures as described herein, such as the various processes described herein or other processes or architectures, can be implemented in resources including computer software such as computer executable code embodied in a computer readable medium, or in electrical circuitry, or in combinations of computer software and electronic circuitry.

Aspects of the systems and methods described herein can be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the devices, systems, and methods include: microcontrollers with memory, embedded microprocessors, firmware, software, etc. Furthermore, aspects of the devices, systems, and methods can be embodied in microprocessors having software-based circuit emulation, discreet logic (sequential and combinatorial), custom devices, fuzzy (neural network) logic, quantum devices, and hybrids of any of the above device types. The underlying device technologies can be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein can be described as data and/or instructions embodied in various computer-readable media, in terms of their behavioral, register transfer, logic component, transistor, layout geometries, and/or other characteristics. Computer-readable media in which such formatted data and/or instructions can be embodied include, but are not limited to, non-volatile storage media in various forms (e.g., optical, magnetic or semiconductor storage media, hard disk, optical disk, magneto-optical disk), volatile media (e.g., dynamic memories) and carrier waves that can be used to transfer such formatted data and/or instructions through wireless, optical, or wired signaling media, transmission media (e.g., coaxial cables, copper wire, fibers optics) or any combination thereof. Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.). Transmission media can include acoustic, optical, or electromagnetic waves, e.g., such as those generated during, e.g., radio frequency (RF) communications or infrared data communications. When received within a computer system via one or more computer-readable media, such data and/or instruction-based expressions of components and/or processes under the systems and methods can be processed by a processing entity (e.g., one or more processors) within the computer system in conjunction with execution of one or more other computer programs.

Processing, computing, calculating, determining, or the like, can refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. Users can be individuals as well as corporations and other legal entities. Furthermore, the processes presented herein are not inherently related to any particular computer, processing device, article or other apparatus. An example of a structure for a variety of these systems will appear from the description herein. Embodiments are not described with reference to any particular processor, programming language, machine code, etc. A variety of programming languages, machine codes, etc. can be used to implement the teachings as described herein.

An electronic device can communicate with other electronic devices, for example, over a network. An electronic device can communicate with an external device using a variety of communication protocols. A set of standardized rules, referred to as a protocol, can be used utilized to enable electronic devices to communicate. In one embodiment, the communications protocol used is HTTP (“Hypertext Transfer Protocol”). HTTP can be an application-level protocol used in connecting servers and users on the World-Wide Web (WWW). HTTP can be based on a request-response mechanism and can use TCP (“Transmission Control Protocol”) connections to transfer data. In another embodiment, HTTPS (“Hypertext Transfer Protocol Secure”), a variant of HTTP that can implement the SSL (“Secure Sockets Layer”) mechanism, is used. SSL can be a standard protocol for implementing cryptography and enabling secure transactions on the Web. SSL can use public key signatures and digital certificates to authenticate a server and user and can provide an encrypted connection for the user and server to exchange messages securely. When HTTPS is the protocol used, the URL (Uniform Resource Locator) defining the HTTPS request is directed to a secure port number instead of a default port number to which an HTTP request is directed. Other protocols can be used to transfer data, for example without limitation, FTP or NFS.

A network can be a small system that is physically connected by cables or via wireless communication (a local area network or “LAN”). An electronic device can be a part of several separate networks that are connected together to form a larger network (a wide area network or “WAN”). Other types of networks of which an electronic device can be a part of include the internet, telcom networks, intranets, extranets, wireless networks, and other networks over which electronic, digital and/or analog data can be communicated.

Communication between the electronic device and an external device can be accomplished wirelessly. Such wireless communication can be bluetooth or RTM technology. In some embodiments, a wireless connection can be established using exemplary wireless networks such as cellular, satellite, or pager networks, GPRS, or a local data transport system such as Ethernet or token ring over a local area network.

An electronic device can be in communication with one or more servers. The one or more servers can be an application server, database server, a catalog server, a communication server, an access server, a link server, a data server, a staging server, a database server, a member server, a fax server, a game server, a pedestal server, a micro server, a name server, a remote access server (RAS), a live access server (LAS), a network access server (NAS), a home server, a proxy server, a media server, a nym server, network server, a sound server, file server, mail server, print server, a standalone server, or a web server. A server can be a computer.

One or more databases can be used to store information from an electronic device. The databases can be organized using data structures (e.g., trees, fields, arrays, tables, records, lists) included in one or more memories or storage devices.

Computer Readable Medium

A computer readable medium can comprise instructions recorded on the computer readable medium suitable for use in an electronic device, e.g., a computer described herein. The computer-readable medium can be non-transitory. Non-transitory computer-readable media can comprise all computer-readable media, with the sole exception being a transitory, propagating signal. Computer readable media can be configured to include data or computer executable instructions for manipulating data. The computer executable instructions can include data structures, objects, programs, routines, or other program modules that can be accessed by a processing system, such as one associated with a general purpose computer capable of performing different functions or one associated with a special purpose computer capable of performing a limited number of functions. Computer executable instructions can cause a processing system to perform a particular function or group of functions and are examples of program codes for implementing steps for methods disclosed herein. A particular sequence of executable instructions can provide an example of corresponding acts that can be used to implement such steps. Computer readable media includes, e.g., a hard disk, diskette, random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), CD±R, CD±RW, DVD, DVD±RW, DVD±R, DVD-RAM, HD DVD, HD DVDR, HD DVD±RW, HD DVD±RAM, Blu-ray Disc, optical or magnetic storage medium, paper tape, punch cards, optical mark sheets or any other device that is capable of providing data or executable instructions that can be accessed by a processing system. Computer readable medium are described, e.g., in U.S. Pat. No. 7,783,072.

Computer code devices can include, e.g., scripts, dynamic link libraries (DLLs), interpretable programs, Java classes and applets, Common Object Request Broker Architecture (COBRA), or complete executable programs.

Systems provided herein can comprise one or more electronic devices that are in electronic communication. The one or more electronic devices can be connected by a wireless and/or wired connection.

### EXAMPLE

### Example 1

### Site Quality Index

Data are analyzed to generate a site quality index, which reflects the site's tendency to produce high quality neurocognitive data (as defined by a number of parameters, including error rates, placebo response rates, or probability of producing fraudulent data). The site quality index can be derived from a variety of different analyses, including rank ordering sites to classify sites along a continuum of performance.

Some neurocognitive administration errors are much more likely to produce significant outlying data, thereby increasing the bias introduced into the study were these errors to be left unchecked. One example of this is errors involving the misapplication of discontinuation rules. These errors may be more likely to produce estimates of cognitive functioning that are more biased than simple arithmetic errors in scoring.

The Wechsler Memory Scale-III: Spatial Span is a test of nonverbal working memory that requires the subject to tap a series of blocks in a specific sequence. Two trials for each sequence are administered, with the sequences incrementing by 1 starting with two of the 2 block sequences and ending with 2 of the 9 block sequences. As per the standard administration rules of the Wechsler Memory Scale-III: Spatial Span, the test is to be stopped after the subject fails both sequences in a given set of sequences (e.g., both 3-block sequences). Failing to follow this rule could result in the patient receiving a much higher (i.e., if the rater fails to discontinue and administers all sequences, enabling additional points to be accrued) or lower (i.e., early discontinuation after a single failed trial could result in the subject receiving a much lower score than they should had the test been allowed to proceed as per the instructions) scores on the test than they should. Such errors can be considered when determining a site quality index.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method of performing a study, the method comprising acquiring a first set of data comprising one or more responses to one or more assessments administered to a subject;
comparing the first set of data from the subject to a second set of data, wherein the comparing comprises execution of an algorithm on an electronic device;
generating a fraud index based on the comparing, wherein the fraud index indicates the probability that the first set of data comprises fraudulent data;
determining the presence or absence of fraudulent data based on the fraud index; and
modifying the first set of data if fraudulent data is present in the first set of data.

2. The method of claim 1, wherein the first set of data and second set of data are neurocognitive data.

3. The method of claim 1, wherein the one or more assessments are one or more neurocognitive assessments.

4. The method of claim 1, wherein the second set of neurocognitive data comprises one or more responses to one or more neurocognitive assessments administered to the subject.

5. The method of claim 1, wherein the second set of neurocognitive data is neurocognitive data previously obtained from the subject.

6. The method of claim 1, wherein the second set of neurocognitive data comprises one or more responses to one or more neurocognitive assessments administered to one or more other subjects that do not include the first subject.

7. The method of claim 1, wherein the one or more other subjects are part of the same study as the first subject.

8. The method of claim 6, wherein the first set of neurocognitive data and the second set of neurocognitive data are derived from the same test.

9. The method of claim 6, wherein the first set of neurocognitive data and the second set of neurocognitive data are derived from the same study.

10. The method of claim 6, wherein the first set of neurocognitive data and the second set of neurocognitive data are derived from different studies within the same therapeutic indication.

11. The method of claim 6, wherein the first set of neurocognitive data and the second set of neurocognitive data are derived from different studies with different therapeutic indications.

12. The method of claim 6, wherein the determining the fraud index is based on a statistical improbability.

13. The method of claim 12, wherein the statistical improbability comprises unusually low inter-subject variability.

14. The method of claim 13, wherein faked data does not fluctuate as would be expected across subjects.

15. The method of claim 12, wherein the statistical improbability comprises unusual inter-session variability.

16-131. (canceled)

132. A method of performing a study, the method comprising
obtaining data concerning the performance of one or more data collection sites in conducting one or more studies;
obtaining information regarding one or more additional features of the one or more data collection sites;
analyzing the information and data, wherein the analyzing comprises executing an algorithm on an electronic device;
generating a site quality index based on the analyzing, wherein the site quality index provides an indication of quality of the one or more data collection sites; and
selecting or excluding one or more data collection sites from a study based on the site quality index.

133.-228. (canceled)

229. A method for performing a study, the method comprising
acquiring a first set of data, wherein the first set of data comprises one or more responses to one or more assessments administered to a subject;
comparing the first set of data to a second set of data, wherein the comparing comprises execution of an algorithm on an electronic device;
determining a data outlier index based on the comparing; and
modifying the first set of data based on the data outlier index.

230-381. (canceled)

382. A method of treating a subject with a condition, the method comprising
administering one or more tests to the subject;
comparing scores from the one or more tests to scores from the one or more tests from one or more other subjects;
generating a responder index based on the comparing, wherein the responder index quantifies the probability that the subject will show an improvement to one or more therapies, wherein the generating comprises executing an algorithm on an electronic device;
comparing the responder index to a threshold;
determining whether the subject is a likely responder based on d); and
enrolling or not enrolling the subject in the clinical trial based on e).

383-434. (canceled)

435. A method of performing a study for a condition, the method comprising
acquiring a first set of data, wherein the first set of data comprises one or more responses to one or more assessments administered to a subject;
acquiring additional information about the subject;
generating a placebo responder index based on the first set of data and the information, wherein the placebo responder index is generated by executing an algorithm on an electronic device; and
modifying the study based on a likelihood the subject will respond to placebo.

436-496. (canceled)

497. A method of generating an optimized neurocognitive battery, the method comprising
administering one or more neurocognitive batteries to a plurality of subjects with a neurocognitive condition;
creating a database of results of the one or more neurocognitive batteries;
analyzing the database by executing an algorithm on an electronic device; and
identifying an optimized neurocognitive battery based on the analyzing.

498-526. (canceled)
